(19) United States
(12) Patent Application Publication
(10) Pub. No.: US 2021/0090017 A1
(43) Pub. Date: Mar. 25, 2021

(54) FEEDBACK-BASED MANAGEMENT OF DELIVERY ORDERS

(71) Applicant: DOORDASH, INC., San Francisco, CA (US)

(72) Inventors: Jesse Lee REISS, San Francisco, CA (US); Benjamin R. BERNSTEIN, San Francisco, CA (US); Matthew RHODES, San Francisco, CA (US)

(21) Appl. No.: 14/667,764

(22) Filed: Mar. 25, 2015

(51) Int. Cl. G06Q 10/08

(52) U.S. Cl. CPC G06Q 10/0833

(57) ABSTRACT

In some examples, a service provider may receive, from a merchant device, merchant feedback communications related to a courier. The merchant feedback may correspond to one or more delivery orders picked up by the courier from a pickup location associated with the merchant. Further, the service provider may receive, from a courier device associated with the courier, feedback communications related to the merchant and corresponding to the one or more respective delivery orders picked up by the courier. Subsequently, the service provider may receive, from a buyer device, an order for delivery of an item from the merchant to a delivery location. In response, the service provider may select the courier to pick up the item from the pickup location and deliver the item to the delivery location based on the merchant feedback received from the merchant device and the courier feedback received from the courier device.

### BACKGROUND

People enjoy eating quality food that is prepared by good restaurants. Nevertheless, sometimes people may not want to go to a restaurant, but instead may prefer to have food delivered to them. To meet this demand, a courier may deliver food prepared by a restaurant to a customer at a delivery location. For example, a service provider may enable customers to order food items from any of a variety of restaurants, and may arrange for couriers to deliver the food items from the restaurants to the customers. However, when making decisions for managing delivery orders, it may be difficult for the service provider to make decisions that can assist in courier retention, while also encouraging restaurant performance and ensuring customer satisfaction with the service.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example system for managing delivery orders based on feedback according to some implementations.

FIG. 2 illustrates an example graphic user interface for presentation on a buyer device according to some implementations.

FIG. 3 illustrates an example graphic user interface for presentation on a courier device according to some implementations.

FIG. 4 illustrates an example graphic user interface for presentation on a merchant device according to some implementations.

FIG. 5 illustrates an example block diagram that includes processing feedback and managing courier assignments based on the feedback according to some implementations.

FIG. 6 is a flow diagram illustrating an example process for selecting couriers based on feedback according to some implementations.

FIG. 7 is a flow diagram illustrating an example process for providing feedback to a merchant according to some implementations.

FIG. 8 illustrates select components of one or more example service computing devices according to some implementations.

FIG. 9 illustrates select components of an example buyer device according to some implementations.

FIG. 10 illustrates select components of an example courier device according to some implementations.

FIG. 11 illustrates select components of an example merchant device according to some implementations.

### DETAILED DESCRIPTION

The technology herein provides a novel system that enables people to participate as couriers in a new type of crowdsourced service economy. With the technology herein, essentially any person with a mobile device is able to immediately become a courier, or cease to be a courier, in a courier network that provides delivery services for delivery of items from merchants to buyers. Additionally, through the interaction of a plurality of computing devices, mobile devices, and location sensors, implementations herein are able to determine courier performance and make decisions on how to manage courier assignments to particular delivery orders based at least in part on feedback from buyers, feedback from merchants, and feedback from the couriers themselves.

Some examples described herein include techniques and arrangements for assigning certain couriers to pick up items from certain merchants based at least in part on merchant feedback regarding the couriers and courier feedback regarding the merchants. Additionally, buyer feedback may also be taken into consideration when determining which couriers to assign to particular orders. In some implementations, a service provider may provide a delivery service that enables buyers to order items, such as food items or other goods, from merchants, such as restaurants. When placing an order with a merchant, the buyer may use a buyer application on a buyer device, such as a mobile device or other computing device, to browse through the items available from various different merchants. The buyer may select a particular item to order from a particular merchant and the service may send information about this selection to the particular merchant. Further, based on the received feedback, the service may select a particular courier to pick up the ordered item from the merchant and deliver the ordered item to a delivery location specified by the buyer.

In the delivery orders herein, there may be typically four participants, i.e., the service provider, a buyer, a merchant, and a courier. Each participant may provide feedback that may be used by the service provider to manage the service. For example, buyers may provide feedback about couriers, merchants, and items provided by the merchants; merchants may provide feedback about couriers, buyers, and items; and couriers may provide feedback about buyers, merchants, and items. Further, the service provider may provide service provider feedback about individual couriers to the individual couriers and/or feedback about individual merchants to the individual merchants. Additionally, in some examples, the buyers, couriers, and/or merchants may provide feedback to the service provider about the service provider and/or the service in general.

In some cases, based on the received feedback from the buyers and the couriers, the service provider can provide at least a portion of the feedback about a merchant employee or an item provided by the merchant to the corresponding merchant to enable the merchant's management to measure the performance of the merchant's employees. For instance, feedback from couriers or buyers regarding missing or unsatisfactory items may be presented to the merchant to provide an indication of employee performance, such as when particular employees are working, or the like. Further, for merchants who consistently receive positive feedback over a period of time, the service provider may provide these merchants with better placement in the buyer application and the service provider website, such as when buyers are shopping for items provided by the merchants. Additionally, or alternatively, merchants who consistently receive positive feedback over a period of time may receive discounted fees from the service provider or other incentives.

As another example, the couriers may provide feedback regarding how merchant employees treat the couriers, and merchant employees can provide feedback regarding how the couriers behave. This bilateral collection of feedback can be used to establish affinity between couriers and merchant employees who work well together or, conversely, to separate couriers and merchant employees who do not get along. Accordingly, the service provider may assign certain couriers to pick up orders from certain merchants based on mutual affinity demonstrated by the merchant feedback regarding the couriers and the courier feedback regarding the merchants. Similarly, if merchant employees and a particular courier do not get along, the service provider can avoid having the particular courier interact with those merchant employees again, which can aid in courier retention.

In some examples, the service provider may attempt to have the same couriers work with same merchants on a regular basis because familiarity can improve efficiency, but the service provider may also ensure, based on the feedback, that the particular couriers and the particular merchant like working with each other. Accordingly, affinity between merchants and couriers can be measured based on the feedback, and the affinity or lack of affinity may be used for assigning particular couriers to pick up orders from particular merchants. Further, in some implementations, the service provider can track which employees of the merchant provide which feedback for which couriers, such as based on which employees are logged in to a merchant application on the merchant device when the feedback is provided. Thus, the service provider and/or the merchant can determine which employee is working at a particular time based on employee login information. For instance, the service provider and/or the merchant can determine which employees gave negative reviews to which couriers and may further determine which employees were working when particular feedback about particular items was provided by the couriers or the buyers.

As still another example, bilateral courier feedback and buyer feedback can establish affinity or lack of affinity for scheduling couriers to deliver items to buyers. For instance, if a particular buyer has given a particular courier negative feedback, the particular courier might not be assigned to deliver orders to the particular buyer in the future. In addition, negative feedback from couriers regarding particular buyers may similarly be used to determine whether to assign particular couriers to deliver items to the particular buyers. Further, there may be couriers that are highly rated by certain merchants and lowly rated by certain buyers or vice versa. Thus, both feedback from the buyers and feedback from the merchants may be taken into consideration in some cases when determining which courier to assign to a particular delivery job.

Each participant, i.e., courier, buyer, and merchant may have a respective computing device that may have a respective application for interacting with the service provided by the service provider, and each of these applications may include a feedback module that enables providing of feedback. Thus, the merchant device may include a merchant feedback module, the courier device may include a courier feedback module, and the buyer device may include a buyer feedback module. For instance, the courier feedback module on the courier device can enable the courier to provide feedback about a buyer or a merchant, as well as view feedback about the courier.

In some cases, rather than being able to view particular feedback from particular buyers or merchants, an individual courier may be able to view a first courier feedback score based on aggregated feedback received from buyers, and a second courier feedback score based on aggregated feedback received from merchants. Additionally, in some examples, a courier may be associated with a third type of feedback score corresponding to particular categories of items, which may also be based at least in part on the feedback from the buyers. For instance, the feedback may indicate that some couriers are better at delivering certain types of items than other types of items.

In addition, the service provider may also determine a service provider-determined fourth type of feedback score for the couriers, e.g., based on the courier meeting service provider expectations regarding picking up orders at predicted pick up times, delivering orders in a timely manner based on predicted travel times from pickup locations to delivery locations, and the like. For instance, the courier device may continually report the location of the courier while the courier is on duty or otherwise active. Thus, the service provider is able to track the movement and progress of the courier toward a pickup location and from the pickup location toward a delivery location for determining the courier's performance. Additionally, by collecting large amounts of courier movement information over a period of time in the past, e.g., for different days of the week and different times of day, the service provider may be able to predict courier travel times for current orders based on the courier location information received over the past period of time. Thus, the service provider can determine courier performance, at least in part, based on a comparison of actual courier travel times with predicted courier travel times.

Further, certain buyer feedback or merchant feedback can be compared with feedback from other buyers and merchants, respectively, to identify untrustworthy buyer feedback or untrustworthy merchant feedback. For instance, a courier that regularly receives highly positive feedback from both merchants and buyers may be directed to merchants or buyers that regularly give negative feedback, such as low ratings or bad reviews, to test the validity of the negative feedback provided by those merchants or buyers, respectively. Feedback from buyers or merchants who are identified as untrustworthy can be ignored, given lesser weight, or otherwise downgraded so that this feedback does not significantly affect courier scores. Courier feedback may be similarly checked for conflicting feedback. Thus, the feedback herein may be examined for conflicts and then any detected conflicts may be resolved by giving less weight to feedback that appears disingenuous.

In addition, a buyer may be able to provide feedback as to whether a delivered item has spoiled, i.e., is in an unsatisfactory condition. In some cases, the spoilage may be based on the delivery time being too long. In other cases, the spoilage may be based on an action of the courier, such as the courier dropping the order. By receiving such feedback over time from a plurality of buyers for a plurality of couriers and/or delivered items, the service provider may be able to determine whether negative feedback is indicative of courier mishap or delivery travel time taking too long, and may use the feedback to determine spoilage times for particular items or categories of items. For instance, a spoilage time may be the time between when an ordered item is ready for pickup and when the ordered item is considered to be of degraded quality, e.g., cold, soggy, melted, wilted, oxidized, or otherwise less palatable than would be normally expected by the buyer. When a spoilage time is determined for an item, the service may prohibit, discourage, or otherwise prevent delivery of the item to a delivery location that is at a sufficiently large distance from a merchant location such that the item is likely to spoil before the delivery can be made.

Some examples herein may include a machine learning model or other computational model that can determine spoilage times from the feedback and determine whether to deliver certain items to certain locations based on the spoilage times. Additionally, the service provider may determine item-level appropriate delivery times, even if not based on spoilage, because there are some items for which buyers are willing to wait longer than other items. Further, in some examples, the computational model can determine that certain couriers are better at delivering certain types or categories of items than other couriers. Consequently, based on the feedback, the computational model may determine courier feedback scores for delivering certain types of items.

As used herein, an order may include a request submitted by a buyer (e.g., a customer) for the acquisition of food items and/or other goods (referred to herein as items) from a merchant. The order information may be received by the service and sent to the merchant. For example, a merchant may include a restaurant or any other business or other entity engaged in the offering of items for delivery to buyers. Actions attributed to a merchant herein may include actions performed by employees or other agents of the merchant and, thus, no distinction is made herein between merchants and their employees unless specifically discussed. In addition, a buyer may include any entity that purchases items from a merchant. Buyers may be customers or potential customers of a particular merchant. The service may receive payment from a buyer for an order and the service may provide payment to the merchant for the order. Further, the service may provide payment to the courier for delivering the order.

For discussion purposes, some example implementations are described in the environment of receiving feedback from multiple different parties having different roles, and using the feedback for managing a delivery service. However, implementations herein are not limited to the particular examples provided, and may be extended to other service environments, other system architectures, other types of goods, other types of services, and so forth, as will be apparent to those of skill in the art in light of the disclosure herein.

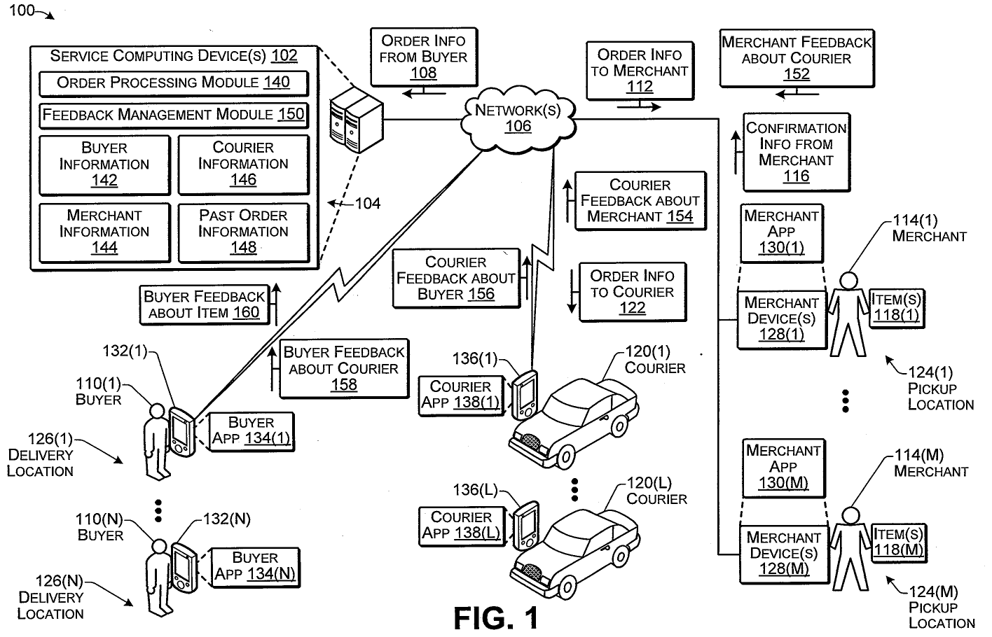

FIG. 1 illustrates an example system 100 for managing a delivery service based on feedback according to some implementations. The system 100 includes one or more service computing devices 102 of a service provider 104 that may receive, over one or more networks 106, order information 108 from a plurality of buyers 110(1)-110(N). The order information 108 may include information about at least one order placed by at least one of the buyers 110. Based on the order information 108 received from a particular buyer 110, the service computing device 102 may send order information 112 to a particular merchant 114 of a plurality of merchants 114(1)-114(M). The particular merchant 114 may receive the order information 112, and may respond with confirmation information 116 to confirm that the particular order has been received and will be prepared by the particular merchant 114.

In some examples, the order information 112 sent to the merchant 114 may identify items 118 ordered by the buyers 110 from the particular merchant 114. For instance, each merchant 114(1)-114(M) may offer one or more respective items 118(1)-118(M), which may be ordered by buyers 110 for delivery. In some cases, the order information 112 may also specify a time at which the order is to be picked up by a courier 120 of a plurality of couriers 120(1)-120(L). For instance, the confirmation information 116 sent by the merchant 114 to the service computing device 102 may confirm the pickup time specified by the service computing device 102. In other cases, the order information 112 sent to the merchant 114 may include an inquiry as to when the order will be ready, and the merchant 114 may include with the confirmation information 116 a specified time at which the order will be ready for pickup.

In response to receiving the confirmation information 116 from the particular merchant 114, the service computing device 102 may send order information 122 to a particular courier 120 who will pick up the order from the particular merchant 114 and deliver the order to the buyer 110 who placed the order. For instance, each merchant 114(1)-114(M) may be associated with a respective pickup location 124(1)-124(M), which may typically be the merchant's place of business. Furthermore, each buyer 110(1)-110(N) may be associated with a respective delivery location 126(1)-126(N) to which the order is to be delivered.

The order information 122 sent to the courier 120 may include the pickup location 124 for the order, the pickup time, and the delivery location 126 for the order. In some examples, the order information 122 may further include a contract time, i.e., a delivery time by which the service provider 104 has agreed to have the ordered item(s) 118 delivered to the buyer 110 at the delivery location 126. Further, in some cases, the order information 122 may include an amount that the courier 120 will be paid if the courier 120 accepts the delivery job, and/or other information related to the order.

In the illustrated example, the service computing device 102 of the service provider 104 is able to communicate with merchant devices 128(1)-128(M) over the one or more networks 106. Each merchant device 128(1)-128(M) may be associated with a respective merchant 114(1)-114(M). Each merchant device 128(1)-128(M) may be a computing device, such as a desktop, laptop, tablet, smart phone, or the like, and may include a respective instance of a merchant application 130(1)-130(M) that executes on the respective merchant device 128(1)-128(M). For example, the merchant application 130 may be configured to communicate with the service computing device 102, such as for receiving the order information 112 and for sending the confirmation information 116. In some examples, the merchant application 130 and the service computing device 102 may communicate with each other via one or more application programming interfaces (APIs). Further, the merchant device 128 may include one or more output devices, such as speakers (not shown in FIG. 1), that the merchant application 130 may use to audibly notify the respective merchant 114 that an order has been received. Additionally, or alternatively, the merchant device 128 may include a display (not shown in FIG. 1) that the merchant application 130 may use for presenting the order information 112 to the merchant 114.

In some examples, the merchant application 130 may provide point-of-sale (POS) functionality to the merchant device 128 to enable the merchant 114 to accept payments using the merchant device 128. Alternatively, in some examples, the merchant device 128 may include a fax machine and the merchant 114 may receive the order information 112 via a facsimile transmission from the service computing device 102. As still another example, the merchant device 128 may be a computing device that is configured to receive order information via email, instant messaging, or other electronic communication. As still another example, the merchant device 128 may include a phone, and the merchant device 128 may receive the order information 112 via an SMS text message, voicemail, telephone call, or the like.

In addition, the buyers 110(1)-110(N) may be associated with respective buyer devices 132(1)-132(N) that may execute respective instances of buyer applications 134(1)-134(N). For example, buyers 110 may use buyer devices 132, such as smart phones, tablet computers, wearable computing devices, laptops, desktops, or the like, and these buyer devices 132 may have installed thereon the buyer application 134. The buyer application 134 may enable the buyer 110 to select one or more of the items 118 to purchase from one or more of the merchants 114 to be delivered to the buyer 110 by one or more of the couriers 120. For example, the buyer application 134 may present one or more GUIs on a display for enabling the buyer 110 to select one or more of the items 118 for an order.

Further, the buyer application 134 may enable the buyer 110 to place an order from a merchant 114 in advance, such as for scheduling an order for delivery at a later time on the same day, at a specified time on a future day, or the like. For instance, the buyer 110 may be able to place an order through the buyer application 134 to have lunch delivered at a specified delivery location by a specified time on a specified day. The buyer application 134 may further enable the buyer 110 to make a payment for an order using the buyer application 134. For instance, the service provider 104 may charge a buyer account associated with the buyer 110 for an amount associated with a particular order. In some examples, the buyer application 134 and the service computing device 102 may communicate with each other via one or more APIs. Additionally, or alternatively, the buyer application 134 may include a web browser, or the like, and the buyer 110 may navigate to a website associated with the service provider 104, and may use the website associated with the service provider 104 to place an order. Thus, in this case, the website may provide at least some of the functionality attributed to the buyer application herein.

In addition, the couriers 120(1)-120(L) may be associated with respective courier devices 136(1)-136(L) that may execute respective instances of courier applications 138(1)-138(L). For example, couriers 120 may use courier devices 136, such as smart phones, tablet computers, wearable computing devices, laptops, or the like, and these courier devices 136 may have installed thereon the courier application 138. The courier application 138 may be configured to receive the order information 122 from the service computing device 102 to provide a particular courier 120 with information for picking up a particular order from a merchant's pickup location 124 and for delivering the order to a buyer delivery location 126. The courier application 138 may further enable the courier 120 to respond to the service computing device 102 to confirm acceptance of a delivery job.

Additionally, in some cases, the courier application 138 may provide the service computing device 102 with an indication of a current location of a particular courier 120. For instance, one or more location sensors associated with each courier device 136 of an active courier 120 may provide location information and, based on this, the courier application 138 may send location information to the service computing device 102, such as by providing an indication of a geographic location of each courier device of each active courier. Thus, a subset of courier devices 136 associated with active couriers may communicate with the service computing device 102, and may continually send location information obtained from one or more location sensors associated with each courier device 136, such as a GPS receiver (not shown in FIG. 1). In some cases, another subset of courier devices 136 associated with inactive couriers may be periodically pinged by the service computing device 102 to determine interest in becoming active. For instance, the ping may include a request for current location information of the associated inactive courier. Couriers who are interested in being activated may allow their courier devices 136 to respond with their location information, while those who are not interested in being activated may keep their location information private by not responding. As one example, if no active courier is predicted to be able to reach a particular pickup location in time to pick up an order, the service provider 104 may seek to activate an inactive courier that is sufficiently close to the particular pickup location to pick up the order on time and deliver the order. In some examples, the courier application 138 and the service computing device 102 may communicate with each other via one or more APIs. Alternatively, in other examples, the courier device 136 may receive the order information 122 via an SMS text message, a voicemail, a telephone call, or the like.

The one or more networks 106 can include any appropriate network, including a wide area network, such as the Internet; a local area network, such an intranet; a wireless network, such as a cellular network, a local wireless network, such as Wi-Fi and/or close-range wireless communications, such as BLUETOOTH® and BLUETOOTH® low energy; a wired network, including fiber optics and Ethernet; or any other such network, or any combination thereof. Accordingly, the one or more networks 106 may include both wired and/or wireless communication technologies. Components used for such communications can depend at least in part upon the type of network, the environment selected, or both. Protocols for communicating over such networks are well known and will not be discussed herein in detail. Accordingly, the service computing device 102, the merchant devices 128, the buyer devices 132, and/or the courier devices 136 are able to communicate over the one or more networks 106 using wired or wireless connections, and combinations thereof.

In the illustrated example, the service computing device 102 includes an order processing module 140 that may be executed on the service computing device 102 to provide, at least in part, the order processing functionality attributed to the service computing device 102. The order processing module 140 may receive the order information 108 from the buyers 110 and may associate the order information 108 with buyer information 142 and merchant information 144. For instance, based on buyer identifying information that may be included with the order information 108, the order processing module 140 may associate particular order information 108 with a particular buyer account. The order processing module 140 may access a buyer account included in the buyer information 142 to charge a particular buyer account for a particular order.

Furthermore, based on a particular merchant 114 identified by the order information 108, the order processing module 140 may associate the order information 108 with a merchant account of a particular merchant. The order processing module 140 may access the merchant account to determine contact information for sending the order information 112 to the correct merchant device 128 so that the particular merchant can receive and provide confirmation of the order. The order processing module 140 may further access the merchant account of the particular merchant to credit payment to the particular merchant that prepares the order.

In addition, the order processing module 140 may access courier information 146 to determine courier contact information for sending the order information 122 to a particular courier 120 of the plurality of couriers 120(1)-120(L) to determine whether the particular courier 120 is willing to accept the delivery job of delivering the order to the buyer. The particular courier 120 may use the courier application 138 on the courier device 136 to receive a message with information about the order, and to respond with acceptance of the delivery job if the job assignment is accepted. The particular courier 120 may subsequently pick up the order from the particular merchant 114 and deliver the order to the particular buyer 110 at a specified delivery location 126. When the courier 120 has completed delivery of the order to the delivery location 126, the courier 120 may use the courier application 138 to inform the order processing module 140 that the delivery has been completed. The order processing module 140 may access a courier account included in courier information 146 for the particular courier 120 to credit the courier account of the particular courier 120 with payment for the delivery job.

The order processing module 140 may store information associated with each order as past order information 148. For instance the past order information 148 may include a day of the week, date, and time of day at which each order is received from the respective buyer 110. The past order information 148 may further include, for each order: merchant identifying information; buyer identifying information; items ordered; the pickup location 124; the delivery location 126; preparation time for the order; location of the courier when the courier accepted the job for delivery of the order; predicted spoilage time for one or more items; time that the order was picked up by the courier; time that the order was delivered; amount paid for the order; as well as other information. Further, as discussed additionally below, the past order information 148 may include feedback received in association with each order, if any. This feedback may include buyer feedback, including any buyer complaints or indications of spoilage, merchant feedback, and/or courier feedback associated with particular orders.

The service computing device 102 may further include a feedback management module 150 that may be executed by the service computing device 102. For instance, the feedback management module 150 may receive feedback from the buyer devices 132, the merchant devices 128, and/or the courier devices 136, and may perform functions for managing the service based at least in part on the received feedback. As one example, when placing an order for an item 118 from a particular merchant 114, the buyer 110 may use the buyer application 134 to place the order. The buyer application 134 may present a GUI on the buyer device 132 that enables the buyer 110 to browse through the items available from various different merchants. The buyer 110 may select a particular item 118 to order from a particular merchant 114 and the service computing device 102 may send information about this selection to the particular merchant 114. Further, the service may arrange for a courier 120 to pick up the ordered item 118 from the merchant 114 and deliver the item 118 to the buyer 110.

The courier 120 may pick up the item 118 from the merchant pickup location 124, such as at a designated pickup time based on preparation time for preparing the item. After the courier 120 has picked up the item 118, the merchant may provide merchant feedback 152 about the courier. For instance, the merchant feedback 152 may include feedback as to whether the courier 120 was on time to pick up the item 118, feedback as to the courier's demeanor or other courier behavior when picking up the item 118, and so forth. Similarly, the courier 120, after picking up the item 118, may provide courier feedback 154 about the merchant 114, which may include feedback about the merchant's employees in some examples. For instance, the courier feedback 154 may include feedback as to whether the item 118 was ready for pickup on time, the condition of the item 118 when picked up, the behavior of the merchant or the merchant's employees during pickup, and so forth.

After picking up the item 118 from the merchant 114, the courier 120 may transport the item 118 from the merchant pickup location 124 to the delivery location 126 specified by the buyer 110. Following delivery of the item 118 to the buyer 110 at the delivery location 126, the courier 120 may provide courier feedback 156 about the buyer, e.g., the buyer 110 was at the delivery location 126 when the courier arrived, the courier did not have to wait a long time for the buyer to answer the door, etc. Further, the buyer 110 may provide buyer feedback 158 about the courier and/or buyer feedback 160 about the item (which may include direct or implicit buyer feedback about the merchant in some cases). For instance, if the ordered item is delivered late, is spoiled, or is in an otherwise unsatisfactory condition, the buyer 110 may leave negative feedback about the courier and/or the item, which may also include negative feedback about the merchant. As another example, if the buyer 110 ordered multiple items 118, and one of the ordered items is missing from the delivered order, the buyer 110 may also leave negative feedback about the item, the merchant, and/or the courier.

As discussed additionally below, the feedback management module 150 may apply the feedback to one or more computations models, and/or may apply management logic to the received feedback to make one or more management decisions with respect to the system 100. For instance, the feedback management module 150 may determine which courier to assign to a particular delivery job based at least in part on the merchant feedback 152 about the couriers and/or the buyer feedback 158 about the couriers and/or the buyer feedback 160 about the items and/or the courier feedback 154 about the merchant and/or the courier feedback 156 about the buyer. Furthermore, the feedback management module 150 may provide at least a portion of the feedback to particular merchants 114 such as to assist the particular merchants in improving their services, providing an indication of employee performance, improving the quality of items provided, and so forth. Additional uses and applications of the feedback herein are discussed below.

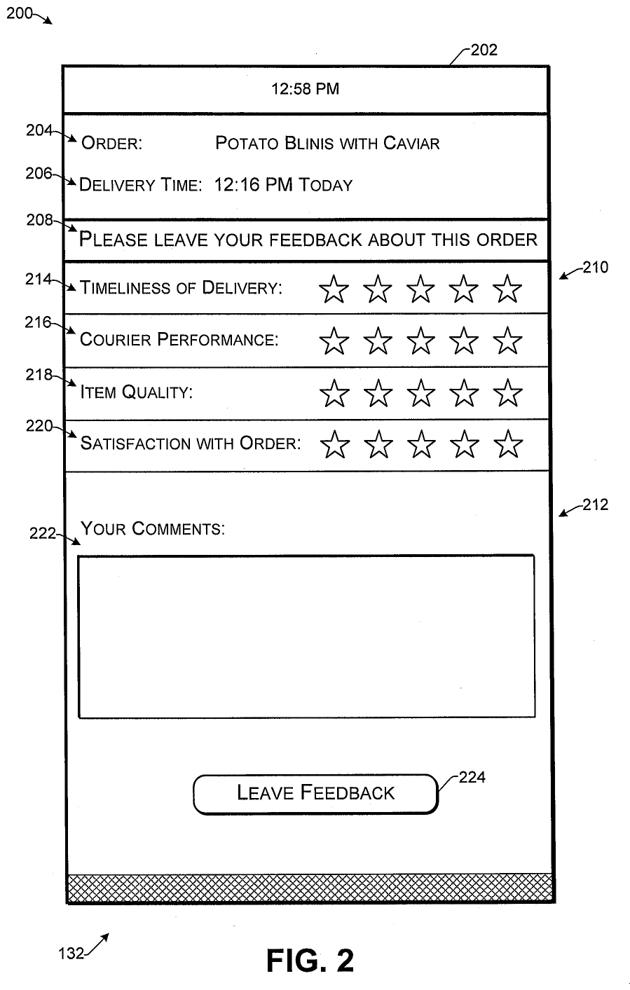

FIG. 2 illustrates an example GUI 200 that may be presented on a display 202 associated with the buyer device 132 to enable a buyer to leave feedback related to an order according to some implementations. The GUI 200 includes an identification of the order 204, such as by describing the item ordered, which in this example was potato blinis with caviar. To further identify the order, the GUI 200 may include the delivery time 206 of the order, which is indicated in this example to have been at 12:16 PM today. Furthermore, as indicated at 208, the GUI 200 may include a request that the buyer provide feedback about the identified order. In some examples, the GUI 200 may be presented on the buyer device 132 any time after the order has been delivered to the buyer.

In in the illustrated example, the GUI 200 includes a first area 210 in which the buyer is able to provide feedback regarding specific aspects about the order, and a second area 212 in which the buyer may provide text comments about the order. Of course, in other examples, the GUI 200 may include one or the other of these areas, or may include various other suitable techniques or interfaces for enabling the buyer to provide feedback about the order.

The first area 210 may include specific inquiries related to the order, which may be answered by the buyer using a star rating method or any other suitable technique for indicating satisfaction or otherwise applying an evaluation to the queried topic. As several examples, the request for feedback may include inquires as to the buyer satisfaction with the timeliness of the delivery, as indicated at 214; buyer satisfaction with the courier performance, as indicated at 216; buyer satisfaction with the item quality, as indicated at 218; and/or buyer satisfaction with the order as a whole, as indicated at 220. Further, while several examples are illustrated in FIG. 2, numerous other feedback inquiries may be apparent to those of skill in the art having the benefit of the disclosure herein.

Additionally, the second area 212 includes a text comment entry box 222 that the buyer may select for entry of one or more text comments related to the order. For instance, the buyer may use a virtual keyboard, voice recognition, or other technique for entering text comments into the comment entry box 222. When the buyer has finished providing the feedback, the buyer may select a “leave feedback” button or other virtual control 224 to send the feedback to the service computing device 102 (not shown in FIG. 2).

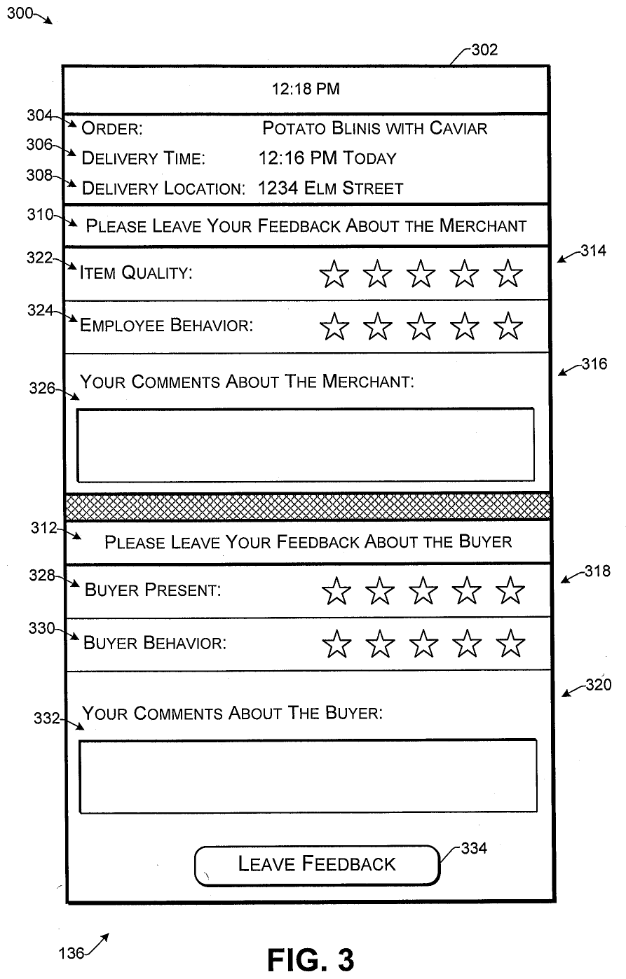

FIG. 3 illustrates an example GUI 300 that may be presented on a display 302 associated with the courier device 132 to enable a courier to leave feedback about the merchant and/or the buyer associated with an order according to some implementations. The GUI 300 includes an identification of the order 304, such as by describing the item ordered, which in this example was potato blinis with caviar. To further identify the order, the GUI 300 may include the delivery time 306 of the order, which is indicated in this example to have been at 12:16 PM today, and the delivery location 308 of the order which in this example is indicated to have been at 1234 Elm Street. Furthermore, as indicated at 310, the GUI 300 may include a request that the courier provide feedback about the identified order. In some examples, the GUI 300 may be presented on the courier device 136 any time after the order has been delivered to the buyer. Furthermore, as indicated at 310, the GUI 300 may include a request that the courier provide feedback about the merchant, and as indicated at 312, the GUI 300 may include a request that the courier provide feedback about the buyer.

In the illustrated example, the GUI 300 includes a first area 314 in which the courier is able to provide feedback regarding specific aspects about the merchant, and a second area 316 in which the courier may provide text comments about the merchant. Furthermore, the GUI 300 includes a third area 318 in which the courier is able to provide feedback regarding specific aspects about the buyer, and a fourth area 320 in which the courier may provide text comments about the buyer. Additionally in other examples, the GUI 300 may include any one of these areas, or may include various other suitable techniques or interfaces for enabling the courier to provide feedback about the merchant and/or the buyer.

In the illustrated example, the first area 314 may include specific inquiries related to the merchant, which may be answered by the courier using a star rating method or any other suitable technique for indicating satisfaction or otherwise applying an evaluation to the queried topic. As several examples, the request for feedback may include inquires as to the item quality, as indicated at 322, such as whether the item was in good condition when picked up, and packaged well enough to stay in that condition by the time delivery was made. Further, as indicated at 316, the courier may be asked about merchant employee behavior, such as demeanor toward the courier, or the like. Additionally, the second area 316 includes a text comment entry box 326 that the courier may use for entry of one or more comments related to the merchant. For instance, the courier may use a virtual keyboard, voice recognition, or other technique for entering comments into the text comment entry box 326.

In addition, the third area 318 may include specific inquiries related to the buyer, which may be answered by the courier using a star rating method or any other suitable technique for indicating satisfaction or otherwise applying an evaluation to the queried topic. As several examples, the request for feedback may include inquires as to whether the buyer was present, as indicated at 328, such as whether the buyer was at the delivery location, or took a long time to answer the door. Further, as indicated at 330, the courier may be asked about buyer behavior, such as demeanor toward the courier, or the like. Additionally, the fourth area 320 includes a text comment entry box 332 that the courier may use for entry of one or more text comments related to the buyer. For instance, the courier may use a virtual keyboard, voice recognition, or other technique for entering comments into the text comment entry box 332.

When the courier has finished entering the feedback, the courier may select a “leave feedback” button or other virtual control 334 to send the feedback to the service computing device 102 (not shown in FIG. 3). Further, while several examples are illustrated in FIG. 3, numerous other feedback queries and techniques for obtaining feedback may be apparent to those of skill in the art having the benefit of the disclosure herein.

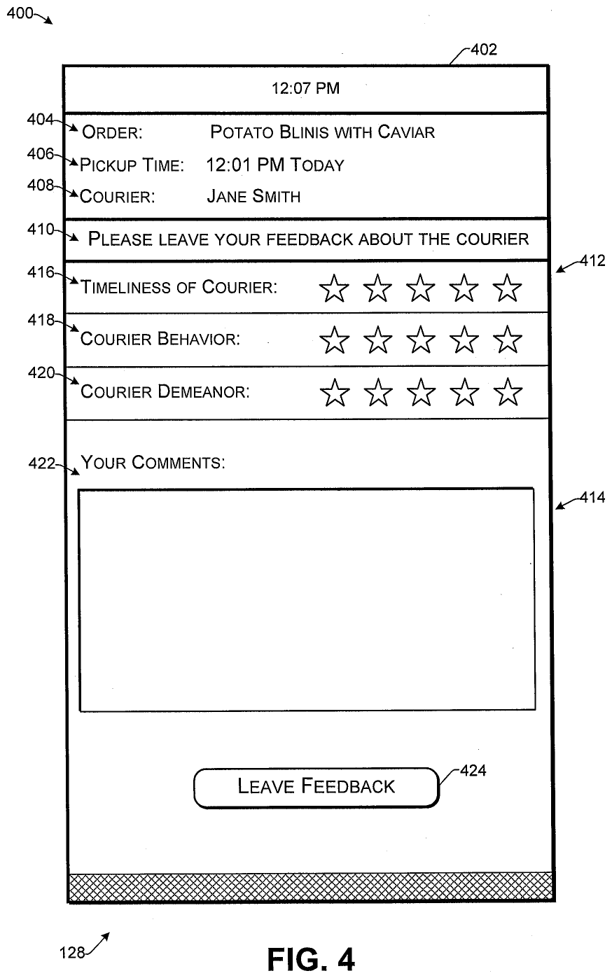

FIG. 4 illustrates an example GUI 400 that may be presented on a display 402 associated with the merchant device 128 to enable a merchant (or employee of the merchant) to leave feedback about a courier according to some implementations. The GUI 400 includes an identification of the order 404, such as by describing the item ordered, which in this example was potato blinis with caviar. To further identify the order, the GUI 400 may include the pickup time 406 of the order, which is indicated in this example to have been at 12:01 PM today. In addition, the GUI 400 may identify, the courier, as indicated at 408, such as by courier name, courier ID number, or the like. Furthermore, as indicated at 410, the GUI 400 may include a request that the merchant leave feedback about the identified order. In some examples, the GUI 400 may be presented on the merchant device any time after the order has been picked up by the courier. Further, in some cases, a particular employee of the merchant may be logged in to the merchant application on the merchant device 128 when providing the feedback about the courier.

In in the illustrated example, the GUI 400 includes a first area 412 in which the merchant is able to provide feedback regarding specific aspects about the courier, and a second area 414 in which the merchant may provide text comments about the courier. Of course, in other examples, the GUI 400 may include one or the other of these areas, or may include various other suitable techniques or interfaces for enabling the merchant to provide feedback about the courier.

The first area 410 may include specific inquiries related to the courier, which may be answered by the merchant using a star rating method or any other suitable technique for providing an evaluation to the queried topic. As several examples, the request for feedback may include inquires as to the timeliness of the courier in picking up the order, as indicated at 416; merchant satisfaction with the courier's behavior while at the merchant's place of business, as indicated at 418; and merchant satisfaction with the courier's demeanor, as indicated at 420. Further, while several examples are illustrated in FIG. 4, numerous other feedback inquiries may be apparent to those of skill in the art having the benefit of the disclosure herein.

Additionally, the second area 414 includes a text comment entry box 422 that the merchant may select for entry of one or more comments related to the courier. For instance, the merchant may use a virtual keyboard, voice recognition, or other technique for entering comments into the text comment entry box 422. When the merchant has finished entering the feedback, the merchant may select a “leave feedback” button or other virtual control 424 to send the feedback to the service computing device 102 (not shown in FIG. 4).

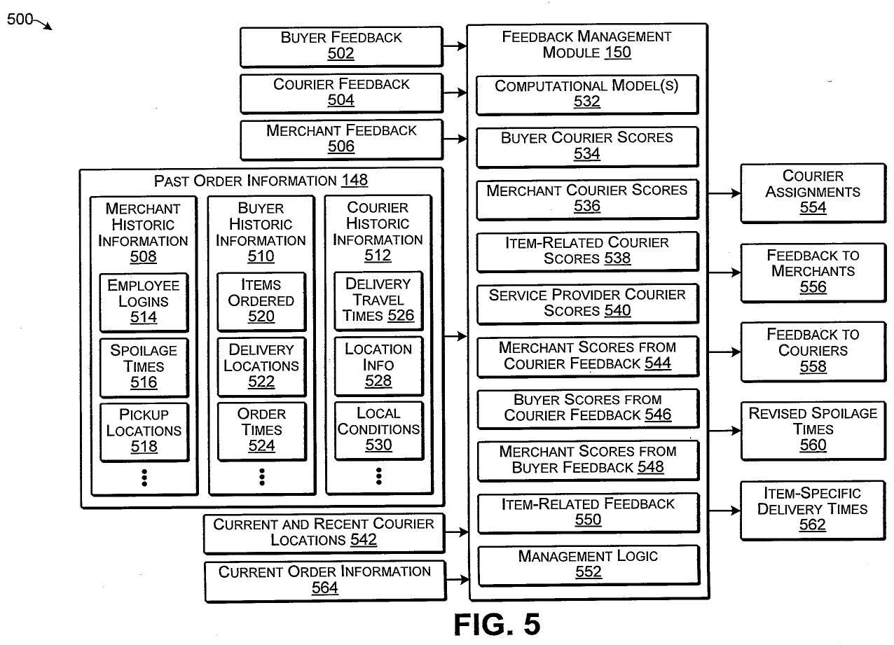

FIG. 5 is a conceptual block diagram 500 illustrating an example of determining information that may be used for determining courier assignments, analyzing feedback, and determining spoilage times and item-specific delivery times according to some implementations. In this example, the feedback management module 150 may receive the buyer feedback 502, the courier feedback 504, and the merchant feedback 506. Further, the feedback module 150 may also receive the past order information 148 that may be associated with the feedback 502, 504, and 506 such that particular feedback 502, 504, and 506 may be associated with past order information 148 for particular respective past orders to which the feedback applies.

The past order information 148 may include merchant historic information 508, buyer historic information 510, and courier historic information 512. Further, while several types of information that may be used by the feedback management module 150 are illustrated, in other examples, other or additional types of information may be used by the feedback management module 150, as discussed herein, and/or as will be apparent to those of skill in the art having the benefit of the disclosure herein.

The merchant historic information 508 includes historic order information related to the merchants, e.g., various types of information related to past orders filled by the merchants that participate in the service of the service provider 104. For instance, the merchant historic information 508 may include employee login information 514, such as which employees were logged in to a merchant device at particular times on particular dates, for particular orders, for particular feedback, and the like. Further, the merchant historic information 508 may include the merchant-indicated spoilage times 516 for each item offered by each merchant, and the pickup locations 518 associated with each merchant. As one example, each merchant may specify an expected spoilage time for each item or each category of item offered by the merchant. In some cases, the merchants may categorize items into spoilage-time-based item categories, such that items having a similar spoilage times are categorized into the same item category. As discussed below, the service provider may determine or adjust these item spoilage times 516 based on buyer feedback 502 and/or courier feedback 504.

Additionally, the buyer historic information 510 includes historic order information related to the buyers. Examples of buyer historic information 510 may include items ordered 520, e.g., which items were ordered by each buyer from particular merchants. The buyer historic information 510 may further include delivery locations 522 to which each order was delivered, and order times 524, e.g., the time of day, and date on which particular orders were placed. For instance, the buyer feedback 502 may be received from the buyer devices and may be associated with particular respective items ordered on particular days at particular times. The buyer feedback 502 may indicate whether an item from an order spoiled prior to being received by the buyer, whether the item was delivered late, whether the buyer did not like the courier, or the like. As discussed additionally below, the buyer feedback 502 regarding particular items may be used to adjust or otherwise change the predicted spoilage times 516 for particular items or categories of items offered by particular merchants and/or may be used to determine item-specific delivery times for items from particular merchants.

Further, the courier historic information 512 includes historic order information related to the couriers. For example, the courier historic information 512 may include delivery travel times 526, which may indicate the time that an order was picked up and the time that the order was delivered, e.g., whether an order was picked up on time and how long it took each courier to deliver each order after picking up the order from the merchant's pickup location. Additionally, location information 528 may include locations of individual couriers at different times of day, for different days of the week in different parts of the service region. For instance, the courier location information 528 may indicate speeds at which couriers are able to travel on different streets in the service region at different times of day, thereby providing an indication of traffic information and an indication of predicted delivery travel times at different times of day and different days of the week. The location information 528 may further indicate how far each courier had to travel after picking up each order to make delivery of the order. In addition, the courier historic information 512 may include local conditions 530, such as traffic conditions and weather conditions when particular orders were fulfilled, information regarding any local events taking place within the service region when the orders were fulfilled, and the like. Furthermore, the merchant historic information 508, the buyer historic information 510, and the courier historic information 512 may include additional types of information, with the foregoing being merely several examples of the types of information that may be used by the feedback management module 150.

In some implementations, the feedback management module 150 may employ one or more computational models 532 for receiving the feedback 502, 504 and 506, and the past order information 148, and for determining buyer courier scores 534, merchant courier scores 536, item courier scores 538, and/or service provider courier scores 540. For instance, the computational model 532 may determine, for each courier, one or more buyer courier scores 534 based on feedback received from the buyers. The buyer courier scores 534 may be determined based on the buyer feedback related to specific topics and/or based on buyer comments. As one example, the computational model 532 may include text recognition capability for determining whether feedback from a particular buyer with respect to a particular courier is positive, negative, or neutral. Thus, the computational model 532 may determine, for each courier, an individual buyer courier score for each buyer that leaves feedback, and an overall buyer courier score that may be an aggregation of the individual buyer courier scores. In some cases, the individual buyer courier scores may be used when determining which courier to assign to a delivery order to be delivered to a particular buyer. For instance, if a buyer has provided negative feedback for a particular courier, then that may weigh, at least in part, against assigning the courier to deliver another order to that buyer. As one example, the scores may be determined, at least in part, based on the star ratings discussed above, e.g., two stars or lower may be a negative score, three stars may be a neutral score, and four stars or higher may be a positive score. In other examples, the scores may be determined, at least in part, based on numerical values assigned to textual feedback as discussed below.

In addition, the computational model 532 may determine, for each courier, one or more merchant courier scores 536 based on feedback received from the merchants. The merchant courier scores 536 may be determined based on the merchant feedback related to specific topics and/or based on merchant comments. Further, the computational model 532 may include text recognition capability for determining whether feedback from a particular merchant (or particular merchant employee) with respect to a particular courier is positive, negative, or neutral. Thus, the computational model 532 may determine, for each courier, an individual merchant courier score for each merchant that leaves feedback, and an overall merchant courier score that may be an aggregation of the individual merchant courier scores. In some cases, the individual merchant courier scores may be used when determining which courier to assign to a delivery order to be picked up from a particular merchant. For instance, if a merchant has provided negative feedback for a particular courier, then that may weigh, at least in part, against assigning the courier to pick up another order from that merchant. Additionally, or alternatively, if negative feedback for a particular courier can be attributed to a particular merchant employee, while positive feedback for the same courier can be attributed to another employee of the same merchant, then the courier assignment to pick up an order from the particular merchant may depend on which employee is currently logged in to the merchant application on the merchant device of the particular merchant.

In some examples, the computational model 532 may determine, for each courier, one or more item-related courier scores 538 based on feedback received from the buyers. The item-related courier scores 538 may be determined based on the buyer feedback related to specific items delivered by the respective courier, which may be determined from e.g., the items ordered 520 and/or text comments included in the feedback received from the buyer. The computational model 532 may include text recognition capability for determining whether feedback from a particular buyer includes a comment about a particular item delivered by the courier. Thus, the computational model 532 may determine, for each courier, individual item-related courier scores 538 for particular different categories of items. For instance, the feedback may indicate that some couriers are better at delivering certain types of items than other types of items. Thus, each courier may have a first item-related score for delivering pizza, a second item-related score for delivering soup, a third item-related score for delivery sandwiches, and so forth. As one example, suppose that a particular courier often spills soup when making deliveries. Accordingly, the item-related courier score for soup may be low, and this item-related courier score may be used when determining whether to assign the particular courier to deliver a new order that includes soup.

In addition, the computational model 532 may be used to determine a service provider courier score 540 for each of the couriers. For example, the service provider courier scores 540 may be determined from the past order information 148, and may be based on the courier meeting service provider expectations regarding picking up orders at predicted pick up times, delivering orders in a timely manner based on predicted travel times from pickup locations to delivery locations, and the like. In some examples, the service provider may receive, from a courier device, an indication of a time when the courier picks up an order from a pickup location and a time at which the courier delivers the order to the delivery location. For instance, the courier device associated with each courier may continually report the location of the courier while the courier is on duty or otherwise active. In some examples, the courier application may automatically send courier location information to the feedback management module 150 on a periodic basis while the associated courier is on-duty or otherwise active. Alternatively, the feedback management module 150 may periodically ping the courier devices of active couriers to determine the couriers' current locations. Each courier device may include one or more location sensors, such as a GPS receiver or communication interfaces that can determine (e.g., from cell towers or wireless access points) a geographic location of the courier device. Thus, the service provider is able to track the movement and progress of the courier toward a pickup location and toward a delivery location for determining the courier's performance.

Additionally, by collecting large amounts of courier movement information over past periods of time, e.g., for different days of the week and different times of day, the service provider is able to predict courier travel times for current orders based on the courier location information received over the past period of time, local conditions 530 during the past periods of time, current local conditions, and the like. The predicted courier travel times may be based in part on the courier historic information 512, such as based on courier location information 528 that indicates courier movement within the service region at particular times, on particular days, on particular dates, during particular types of weather, or while other local conditions 530 are in effect.

The predicted courier travel times may further be based at least in part on current information, such as weather forecast information and local event information. As one example, based at least in part on the one or more computational models 532, the feedback management module 150 may determine a confidence score for a prediction of how long it will take a courier to travel from a first point to a second point within the service region at a particular time on a particular day of the week. Current and recent courier location information 542 may also be considered when determining the predicted courier travel times. For example, recent courier movement, or lack thereof, may indicate unexpectedly heavy traffic. Additionally, in some examples, traffic information from an online map service, such as may be obtained from a webserver or other network source, may also be used or taken into consideration by the computational model 532 when determining the predicted courier travel times. Accordingly, based on how closely couriers match the predicted courier travel times, the computational model 532 may generate service provider courier scores 540 for each courier.

In addition, the computational model 532 may determine merchant scores 544 from courier feedback 502. For example, the couriers may provide the courier feedback 502 that includes feedback about merchants from whom the couriers picked up orders. For instance, the couriers may provide feedback for individual orders, such as regarding the quality or other condition of an item at the time of pickup and/or at the time of delivery. The courier may view the item or otherwise inspect the item during pickup and/or during delivery, or the courier may ask the buyer if the item is in satisfactory condition during delivery. As discussed above, a courier may use a GUI presented on the courier device to provide feedback on the condition of a particular item for a particular delivery order at the time of pickup and/or delivery. In addition, the courier may provide feedback on the merchant and/or the employees of the merchant such as based on how the courier is treated by the merchant or the employees of the merchant. For instance, if a courier provides feedback indicating that the courier is not well treated by a merchant or particular employees of the merchant, the service provider may avoid assigning the particular courier to picking up orders from that merchant again in the future. Accordingly, the computational model 532 made determine merchant scores 544 from the courier feedback, such as a first merchant score related to the quality of the item provided by the merchant, and a second merchant score related to the treatment of the courier by the merchant. As one example, the scores may be determined based on the star ratings discussed above, e.g., two stars or lower may be a negative score, three stars may be a neutral score, and four stars or higher may be a positive score. The second merchant score may be used in combination with the merchant courier score 536 discussed above when determining whether to assign a particular courier to pick up an order from a particular merchant.

Similarly, the computational model 532 may determine buyer scores 546 from courier feedback 504. For example, the courier may provide feedback about particular buyers such as with regard to whether the buyer was at the delivery location when the courier arrived, whether the buyer took a long time to answer the door after the courier's arrival or the like. Accordingly, the computational model 532 may establish a buyer score for particular buyers with respect to particular couriers, which may be used in combination with the buyer courier scores 534 discussed above when deciding whether to assign a particular courier to deliver an order to a particular buyer. As one example, the buyer scores 546 may be determined based on the star ratings discussed above, e.g., two stars or lower may be a negative score, three stars may be a neutral score, and four stars or higher may be a positive score. Furthermore, in some examples the couriers may be provided with an incentive to provide the feedback about the merchants and/or the buyers, such as for additional compensation, points towards courier benefits, rewards, prizes, or other types of incentives.

In addition, the computational model 532 may determine merchant scores 548 based on buyer feedback 502. For instance, buyers may leave feedback with regards to the quality of the item delivered and this feedback may be attributed at least in part to the merchant that provided the item. Accordingly, the computational model made determine merchant scores 548 for particular items or categories of items provided by each merchant, and these scores may be provided to corresponding the merchant, such as to inform the merchant as to the perceived quality of the items provided by the merchant at the time of delivery.

Furthermore, the computational model 532 may determine item-related feedback 550 from the buyers and/or the couriers. For example, the item-related feedback 550 may indicate that an item was spoiled when delivered, which may indicate that the actual spoilage time for the item is shorter than the indicated spoilage time 516. The spoilage time may be the time between when an ordered item is ready for pickup and when the ordered item is considered to be of degraded quality, e.g., cold, soggy, melted, wilted, oxidized, or otherwise less palatable than would be normally expected by the buyer. For instance, the service provider may determine delivery zones for particular merchants and/or for particular items provided by the merchants based at least in part on the spoilage times 516. To ensure quality of the delivered items, the service provider might prevent buyers from ordering a particular item for delivery to a delivery location to which the courier travel time is greater than the spoilage time of the particular item. For example, such items might not be presented to the buyer when the buyer is shopping for items with the buyer application. Accordingly, when feedback from a plurality of buyers and/or couriers indicates that a particular item has been delivered in a spoiled or otherwise unsatisfactory condition, and the unsatisfactory condition may be attributed at least in part to the amount of time expended for delivery of the item, the spoilage time for the item may be shortened or otherwise revised.

As one example, suppose that a particular item, such as French fries from a first merchant, has been delivered to a large number of buyers within a delivery zone of the first merchant. Furthermore, suppose that a threshold number of complaints or other negative feedback from buyers and/or couriers has been received regarding the quality of the French fries from the first merchant. In some cases, the computational model 532 may apply parsing and text recognition for determining, from particular orders, the item to which the negative feedback applies. For instance, words such as “soggy”, “cold”, “gross”, etc., when included in the same comment as “fries” may indicate that the French fries were received in an unsatisfactory condition. Additionally, in some cases of spoilage, the buyer may request a refund, or may request a replacement item, which may also be an indication of spoilage of the replaced item. Consequently, when a threshold level of negative feedback has been received for an item or a category of items from a particular merchant, the predicted spoilage times for the item or category of items may be adjusted to be a shorter length of time. As another example, if no negative feedback related to spoilage is received for particular items or particular categories of items from a particular merchant, the spoilage times 516 for the item or category of items may be gradually increased until such a time as negative feedback related to spoilage is received, and the spoilage times may then be lowered back down slightly.

As still another example, the item-related feedback 550 may be used to determine item-specific acceptable delivery times for some items that are different from the spoilage times for the items. For example, suppose that some items have a long preparation time such as 45 minutes to an hour and that buyers are willing to wait this additional time for these particular items from particular merchants whereas the buyers may not expect to wait so long for similar items from other merchants without complaining. As an example, suppose that a particular type of pizza from a first merchant is a highly popular type of pizza that takes 45 minutes to make and cook, whereas an average pizza only takes 15 minutes. Accordingly, the feedback from the buyers may indicate that the buyers do not mind waiting for the particular type of pizza from the first merchant, and this may be indicated by receiving very few buyer complaints even though the overall time between ordering and delivery may be over one hour, whereas the average time between ordering and delivery of a typical pizza may be one half hour, with many buyers complaining if the delivery takes an hour. Accordingly, based on positive feedback or lack of negative feedback from the buyers, the particular type of pizza from the first merchant may be associated with an item-specific delivery time that is different from item specific delivery times of the typical pizza.

In some examples, the computational model(s) 532 may include one or more trained statistical models that account for numerous pieces of information included in the past order information 148, as well as received feedback 502, 504 and 506 when determining the scores 534-540, 544-548, changes to spoilage times, item-specific delivery times, and the like. In some cases, the one or more statistical models may be initially trained using a set of training data, checked for accuracy, and then used for determining the meaning of feedback from text comments, determining feedback-related scores 534-540, 544-548, determining spoilage times, and/or determining predicted courier travel times, such as based on a confidence level exceeding a specified threshold of confidence. The statistical model(s) may be periodically updated and re-trained based on new training data to keep the model(s) up to date and accurate. Examples of suitable statistical models that may be incorporated into the computational model(s) 532 herein may include regression models, such as linear and nonlinear regression models, and stochastic models, such as Markov models, hidden Markov models, and so forth.

As one example, the statistical model may be used to classify text comments that are received as part of the feedback. For instance, the statistical model may search text of the text comments based at least in part on comparing words in the text with a plurality of reference words. As one example, with respect to feedback received about couriers, the statistical model may identify words in the text comments indicative of merchant feedback related to the individual couriers, or words in the text indicative of buyer feedback related to the individual couriers. Further, the statistical model may classify the text comments into one or more comment classifications. For instance, the comment classifications may be associated with respective numerical values, e.g., the text comments from the merchants may be associated with a first set of comment classifications and the text comments from the buyers may be associated with a second set of comment classifications. Thus, the statistical model may determine, for the individual couriers, at least a portion of the merchant courier scores 536 from the respective merchants based at least in part the numerical values associated with the first set of comment classifications, and may determine at least a portion of the buyer courier scores 534 from the respective buyers based at least in part on the second set of comment classifications. Text comments from the couriers may be similarly processed and applied to the merchant scores 544 and the buyer scores 546.

Additionally, while the computational model 532 has been described as one example of a technique for determining feedback-related scores 534-540, 544-548, determining spoilage times, and/or determining predicted courier travel times, numerous other techniques, algorithms, decision-making rules, and the like, may additionally or alternatively be used for determining this information. Accordingly, implementations herein are not limited to use of a computational model 532.

After the feedback management module 150 has determined the buyer courier scores 534, the merchant courier scores 536, the item-related courier scores 538, the service provider courier scores 540, the merchant scores 544 from courier feedback, the buyer scores 546 from courier feedback, the merchant scores 548 from buyer feedback, and/or the item-related feedback 550, the feedback management module 150 may apply management logic 552 to these scores and item-related information, such as to generate management decisions for managing couriers and/or orders. In some examples, the management logic 552 may include one or more algorithms, one or more computational models, a plurality of decision-making rules, or the like, configured to determine at least one of courier assignments 554, feedback to merchants 556, feedback to couriers 558, revised spoilage times 560, or item-specific delivery times 562.

As one example, the management logic 552 may receive current order information 564 for an order placed by a buyer. The current order information 564 may include information about at an item ordered from a first merchant and an indicated delivery location. Thus, the feedback module 150 may select a particular courier of a plurality of active couriers to assign to picking up the order from the pickup location associated with the first merchant and to deliver the order to the delivery location associated with the buyer. When selecting the particular courier, the management logic 552 may refer to the current and recent courier locations 542 to determine a subset of couriers who are near enough to the pickup location of the merchant to be able to pick up the item by the time the item is prepared. For instance, the merchant may provide an indication of when the item will be ready for pick up. Using the travel time predication techniques discussed above, the management logic 552 may determine predicted travel times for the plurality of couriers based on the current indicated locations of the couriers to obtain the subset of couriers who are in close enough proximity to the pickup location to be able to pick up the item on time when the item is ready.

From the couriers in the subset, the management logic may apply some or all of the buyer courier scores 534, the merchant courier scores 536, the item-related courier scores 538, the service provider courier scores 540, the merchant scores 544 from courier feedback, and the buyer scores 546 from courier feedback. As one example, each score may be evenly weighted, e.g., supposed that for a first courier, the buyer courier score 534 from this buyer is “3” (i.e., the buyer gave the first courier three stars in the past); the merchant courier score is “4” (i.e., the merchant gave the first courier four stars in the past); the item-related courier score 538 for the ordered item for the first courier is “5” (i.e., the courier has delivered this category of item in the past, has received five stars from buyers to whom the item was delivered, and has not received any complaints attributable to the courier when delivering this category of item); merchant score 544 from the first courier for this merchant is “2” (i.e., the first courier felt that he or she was not well treated in the past by the employees of this merchant and only gave feedback of two stars on several occasions); and the courier buyer score 546 from the first courier for this particular buyer is “3” (i.e., the courier gave the buyer three stars since the buyer was on the phone the last time the first courier delivered an order to the buyer, and the courier had to knock several times. Accordingly, the multiple scores may be added to determine an overall courier affinity for the current delivery job, i.e., 3+4+5+2+3=17.

Such overall scores may be computed for each of the couriers in the subset, and the courier with the highest score may be assigned to the delivery job. If a particular courier in the subset has not yet interacted with at least one of the buyer, the merchant, or the category of item, a neutral score of “3” or other suitable score, may be used. Further, the service provider courier score 540 is not used in this example, but may be applied in other examples. In addition, while the above example applies equal weight to all the scores, in other examples, different weightings may be applied. For instance, scores indicative of courier-merchant affinity (i.e., merchant courier score 536 and merchant score 548 from buyer feedback) may be given greater weight than scores indicative of courier-buyer affinity (i.e., buyer courier score 534 and buyer score 546 from courier feedback). Scores of less than “3” may be treated as negative numbers and may be give greater weight that scores greater than “3”, and so forth. Numerous other variations and scoring systems will be apparent to those of skill in the art having the benefit of the disclosure herein.

As mentioned above, the bilateral collection of feedback from couriers and merchants can be used to establish affinity between particular couriers and particular merchant employees who work well together or, conversely, to separate couriers and merchant employees who do not get along. Accordingly, using the scoring technique discussed above, or other suitable techniques, the management logic 552 may assign certain couriers to pick up orders from certain merchants based on the merchant feedback regarding the couriers and the courier feedback regarding the merchants. If particular merchant employees and a particular courier do not get along, the management logic 552 can avoid having the particular courier interact with that merchant again, which can aid in courier retention.

In some examples, the management logic 552 may attempt to have the same couriers work with same merchants on a regular basis because familiarity can improve efficiency, but the management logic 552 may also ensure, based on the feedback from the couriers and the feedback from the merchant, that the particular couriers and the particular merchant employees like working with each other. Further, in some cases, the management logic 552 can track which employees of a particular merchant provide which feedback for particular couriers, such as based on which employees are logged in to a merchant device when the feedback is provided. Thus, the management logic 552 can determine which employee is working at a particular time based on employee login. For instance, the management logic 552 can determine which employees gave negative feedback to particular couriers, and which employees gave positive feedback to particular couriers. Thus, if an employee who gave a positive review to a particular courier is logged in to the merchant device, then the particular courier may be assigned to pick up an order from the merchant. On the other hand, if an employee who gave a negative review to the particular courier is logged in to the merchant device, the particular courier might not be assigned to pick up the order from the particular merchant. This can be similarly applied to courier feedback for merchant employees who were logged in when particular feedback for the merchant employees was provided by the particular courier.

In some cases, based on the received feedback from the buyers and the couriers, the management logic 552 may provide at least a portion of the feedback to the corresponding merchant as the feedback to merchants 556. For instance, the feedback 556 may be provided the particular merchant to enable the merchant's management to gauge the performance of the merchant's employees. For instance, courier feedback 504 and/or the buyer feedback 502 regarding missing items may be presented to the merchant in a GUI on the merchant device to provide an indication of employee performance, such as at particular times when particular employees are working, or the like. As one example, the employees of a merchant may log in to the merchant application when using the merchant device for receiving orders and leaving feedback, and this log in information may be associated with particular orders by the feedback management module 150. As another example, the couriers may provide feedback regarding how merchant employees treat the couriers, and this feedback may be aggregated across couriers who have interacted with the employees to determine a rating for the employee treatment of the couriers. This information may also be provided to the merchant as feedback to merchant 556. Further, for merchants who consistently receive positive feedback over a period of time, the service provider may provide these merchants with better placement in the buyer application and the service provider website, such as when buyers are shopping for items provided by the merchants. Additionally, or alternatively, merchants who consistently receive positive feedback over a period of time may receive discounted fees from the service provider or other incentives.

As still another example, bilateral courier feedback and buyer feedback can establish affinity or lack of affinity for scheduling couriers to deliver items to buyers. For instance, if a particular buyer has given a particular courier negative feedback, the particular courier might not be assigned to deliver orders to the particular buyer in the future. In addition, negative feedback from couriers regarding particular buyers may similarly be used to determine whether to assign particular couriers to deliver items to particular buyers. Further, both feedback from the buyers and feedback from the merchants may be taken into consideration in some cases when determining which courier to assign to a particular delivery job, such as by applying the scoring system discussed above.

In addition, the management logic 552 may provide feedback to couriers 558, such as to provide constructive criticism to particular couriers. In some cases, rather than being able to view particular feedback from particular buyers or merchants, an individual courier may be able to view overall feedback scores based on aggregated buyer courier scores 534 and/or aggregated merchant courier scores 536 and/or the item-related courier score 538. In addition, the management logic 552 may also provide the service provider courier score 540 as part of the feedback to couriers 558.

Furthermore, as discussed above, the computational model 532 may compare certain buyer feedback or merchant feedback with feedback from other buyers and merchants, respectively, to identify untrustworthy buyer feedback or untrustworthy merchant feedback. For instance, a courier that regularly receives positive feedback from both merchants and buyers may be subsequently directed by the management logic 552 to merchants or buyers that regularly give negative feedback to test the validity of the negative feedback provided by those merchants or buyers, respectively. Feedback from buyers or merchants who are identified as untrustworthy can be ignored, given lesser weight, or otherwise downgraded so that this feedback does not significantly affect courier scores. Courier feedback may be similarly checked for conflicting feedback. Thus, the feedback herein may be examined for conflicts and then any detected conflicts may be resolved by giving less weight to feedback that appears disingenuous.

In addition, as mentioned above, a buyer may be able to provide feedback as to whether a delivered item has spoiled. Based on receiving such feedback over time from a plurality of buyers for a plurality of couriers and/or delivered items, the management logic 552 may use the feedback to determine revised spoilage times 560 for particular items or categories of items. When a spoilage time is determined for an item, the management logic 552 may prohibit or otherwise discourage delivery of the item to a delivery location that is sufficiently far from a merchant location such that the item is likely to spoil before the delivery can be made. Additionally, the management logic 552 may determine item-specific delivery times 562 for particular, even if not based on spoilage, because there are some items for which buyers are willing to wait longer than other items.

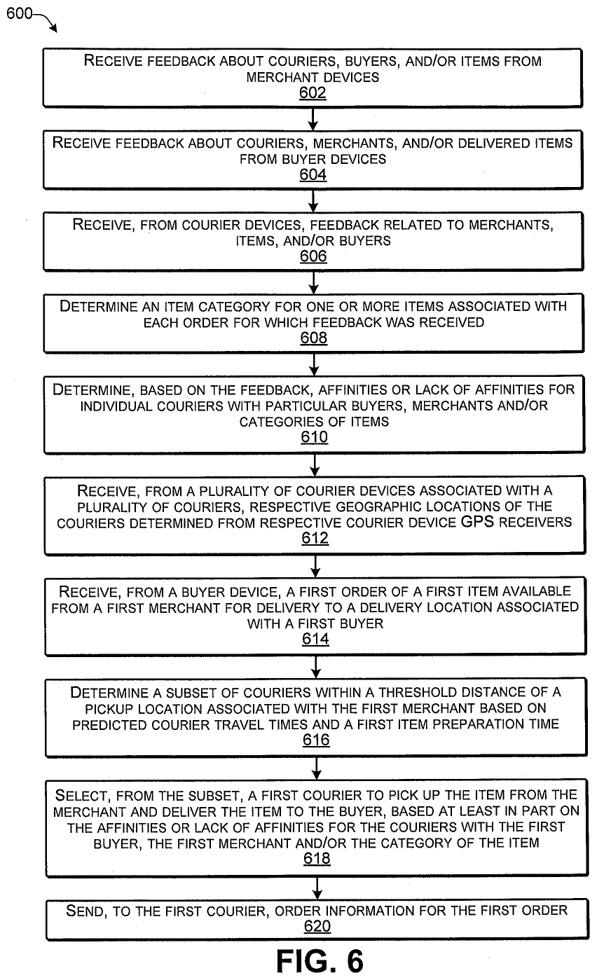

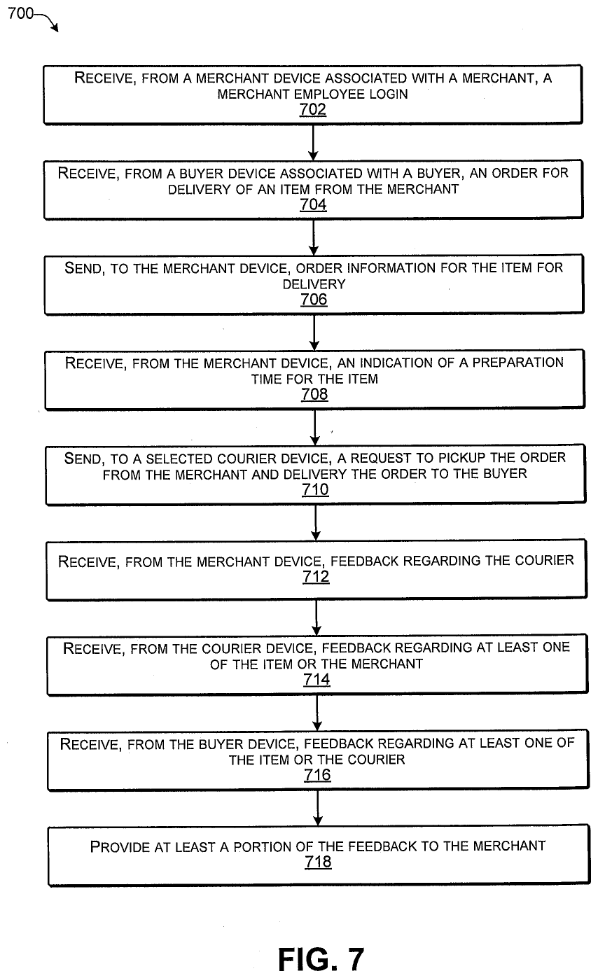

FIGS. 6 and 7 are flow diagrams illustrating example processes according to some implementations. The processes are illustrated as collections of blocks in logical flow diagrams, which represent a sequence of operations, some or all of which can be implemented in hardware, software or a combination thereof. In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation. Any number of the described blocks can be combined in any order and/or in parallel to implement the process, or alternative processes, and not all of the blocks need be executed. For discussion purposes, the processes are described with reference to the environments, systems and devices described in the examples herein, although the processes may be implemented in a wide variety of other environments, systems and devices.

FIG. 6 is a flow diagram illustrating an example process 600 according to some implementations. In some examples, the process may be executed in part by the service computing device 102 and in part by the buyer devices 132, the courier devices 136 and/or the merchant devices 128.

At 602, the service computing device, may receive feedback about couriers, buyers, and/or items from merchant devices. For example, the service computing device may receive, from a plurality of merchant devices, a first plurality of feedback communications including at least one of ratings or text comments related to individual couriers of a plurality of couriers. For instance, the respective feedback communications may correspond to respective delivery orders picked up by the individual couriers from the respective merchants. Additionally, in some cases the merchants might provide feedback about a buyer, such as favorable feedback about buyers who order often from the merchants. Further, in some examples, merchants may provide feedback about items, such related to preparation times, spoilage times, and the like.

At 604, the service computing device may receive feedback about couriers, merchants, and/or delivered items from buyer devices. For example, the service computing device may receive, from a plurality of buyer devices, a second plurality of feedback communications including at least one of ratings or text comments related to the individual couriers. For instance, the respective feedback communications of the second plurality of feedback communications may correspond to respective delivery orders delivered by the individual couriers to the respective buyers. Further, the service computing device may receive, from a plurality of buyer devices, feedback about items and/or merchants. For example, the feedback may be indicative of item spoilage or other buyer dissatisfaction with the delivered item.

At 606, the service computing device may receive, from courier devices, feedback related to merchants, feedback related to items, and/or feedback related to buyers. For example, the service computing device may receive, from a courier device, courier feedback communications related to at least one of a merchant, a buyer, or a delivered item.

At 608, the service computing device may determine an item category for one or more items associated with each order for which feedback was received. For example, the service computing device may determine from order information associated with the respective delivery orders for which the feedback communications were received from the buyer devices, an item category for one or more items associated with the respective delivery orders delivered by the individual couriers to the respective buyers. Subsequently, the service computing device may determine, for the individual couriers, courier scores for respective item categories based on the feedback communications received from the buyer devices, and may select couriers for delivery jobs based at least in part on the respective courier scores for particular item categories associated with items to be delivered.

At 610, the service computing device may determine, based on the feedback, affinities or lack of affinities of individual couriers with particular buyers, particular merchants, and/or particular categories of items. For example, the service computing device may determine, for the individual couriers, first respective courier scores for the respective merchants based on the first plurality of feedback communications received from the plurality of merchant devices, and second respective courier scores for the respective buyers based on the second plurality of feedback communications received from the buyer devices.

At 612, the service computing device may receive, from a plurality of courier devices associated with a plurality of couriers, respective geographic locations of the couriers determined from respective courier device GPS receivers.

At 614, the service computing device may receive, from a buyer device, a first order of a first item available from a first merchant for delivery to a delivery location associated with a first buyer.

At 616, the service computing device may determine a subset of couriers within a threshold distance of a pickup location associated with the first merchant based on predicted courier travel times and a first item preparation time. In some examples, the service provider may maintain a list of item preparation times, while in other examples, the service provider may receive the expected item preparation time from the merchant, such as with confirmation of receipt of the order.

At 618, the service computing device may select, from the subset, a first courier to pick up the item from the merchant and deliver the item to the buyer, based at least in part on the affinities or lack of affinities for the couriers with the first buyer, the first merchant and/or the category of the item. For example, the service computing device may select, from a subset of couriers associated with the subset of courier devices, a first courier to pick up the first item from the first merchant and deliver the first item to the delivery location. The selecting may be based at least in part on the first respective courier score associated with the first courier for the first merchant and the second respective courier score associated with the first courier for the first buyer. Further, in some examples, the selecting may also be based on the courier feedback communications received from the first courier device with respect to the first merchant and/or the first buyer, and/or the courier's score for a particular item category associated with the first item.

At 620, the service computing device may send, to the first courier, order information for the first order. For example, the service computing device may assign the delivery job to the particular courier based on the courier scores.

FIG. 7 is a flow diagram illustrating an example process 700 according to some implementations. In some examples, the process may be executed by the service computing device 102 or by another suitable computing device.

At 702, the computing device may receive, from a merchant device associated with a merchant, a merchant employee login. For example, the service computing device may receive log in information when an employee logs in to the merchant application on the merchant device. Alternatively, in other examples, the merchant employee login timing may be maintained by the merchant.

At 704, the computing device may receive, from a buyer device associated with a buyer, an order for delivery of an item from the merchant.

At 706, the computing device may send, to the merchant device, order information for the item for delivery. For example, the service computing device may send information about the item requested by the buyer.

At 708, the computing device may receive, from the merchant device, an indication of a preparation time for the item. For instance, the merchant may send the predicted item preparation time to the service computing device.

At 710, the computing device may send, to a selected courier device, a request to pick up the order from the merchant and deliver the order to the buyer. As discussed above, the service computing device may select a particular courier based on affinity with merchant and/or the buyer and/or the item ordered.

At 712, the computing device may receive, from the merchant device, feedback regarding the courier. For instance, the merchant employee may provide feedback about the courier.

At 714, the computing device may receive, from the courier device, feedback regarding at least one of the item or the merchant. For example, the courier may provide feedback about the merchant employee or the item.

At 716, the computing device may receive, from the buyer device, feedback regarding at least one of the item or the courier. For example, the buyer may provide feedback about the courier or the item prepared by the merchant.

At 718, the computing device may provide at least a portion of the feedback to the merchant. For example, the feedback provided to the merchant may be indicative of employee performance, and may, in some examples, be presented to merchant management, rather than to the employee.

The example processes described herein are only examples of processes provided for discussion purposes. Numerous other variations will be apparent to those of skill in the art in light of the disclosure herein. Additionally, while the disclosure herein sets forth several examples of suitable frameworks, architectures and environments for executing the processes, implementations herein are not limited to the particular examples shown and discussed. Furthermore, this disclosure provides various example implementations, as described and as illustrated in the drawings. However, this disclosure is not limited to the implementations described and illustrated herein, but can extend to other implementations, as would be known or as would become known to those skilled in the art.

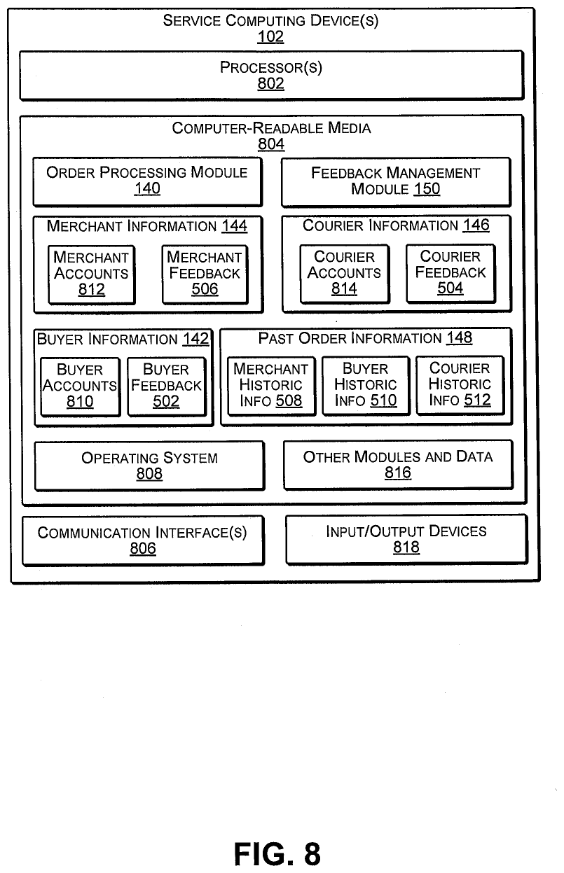

FIG. 8 illustrates select components of the service computing device 102 that may be used to implement some functionality of the feedback-based management and order processing services described herein. The service computing device 102 may include one or more servers or other types of computing devices that may be embodied in any number of ways. For instance, in the case of a server, the modules, other functional components, and data may be implemented on a single server, a cluster of servers, a server farm or data center, a cloud-hosted computing service, and so forth, although other computer architectures may additionally or alternatively be used.

Further, while the figures illustrate the components and data of the service computing device 102 as being present in a single location, these components and data may alternatively be distributed across different computing devices and different locations in any manner. Consequently, the functions may be implemented by one or more service computing devices, with the various functionality described above distributed in various ways across the different computing devices. Multiple service computing devices 102 may be located together or separately, and organized, for example, as virtual servers, server banks and/or server farms. The described functionality may be provided by the servers of a single entity or enterprise, or may be provided by the servers and/or services of multiple different entities or enterprises.

In the illustrated example, each service computing device 102 may include one or more processors 802, one or more computer-readable media 804, and one or more communication interfaces 806. Each processor 802 may be a single processing unit or a number of processing units, and may include single or multiple computing units or multiple processing cores. The processor(s) 802 can be implemented as one or more microprocessors, microcomputers, microcontrollers, digital signal processors, central processing units, state machines, logic circuitries, and/or any devices that manipulate signals based on operational instructions. For instance, the processor(s) 802 may be one or more hardware processors and/or logic circuits of any suitable type specifically programmed or configured to execute the algorithms and processes described herein. The processor(s) 802 can be programmed or otherwise configured to fetch and execute computer-readable instructions stored in the computer-readable media 804, which can program the processor(s) 802 to perform the functions described herein.

The computer-readable media 804 may include volatile and nonvolatile memory and/or removable and non-removable media implemented in any type of technology for storage of information, such as computer-readable instructions, data structures, program modules, or other data. Such computer-readable media 804 may include, but is not limited to, RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the service computing device 102, the computer-readable media 804 may be a type of computer-readable storage media and/or may be a tangible non-transitory media to the extent that when mentioned, non-transitory computer-readable media exclude media such as energy, carrier signals, electromagnetic waves, and signals per se.

The computer-readable media 804 may be used to store any number of functional components that are executable by the processors 802. In many implementations, these functional components comprise instructions or programs that are executable by the processors 802 and that, when executed, specifically configure the one or more processors 802 to perform the actions attributed above to the service computing device 102. Functional components stored in the computer-readable media 804 may include the order processing module 140 and the feedback management module 150. Additional functional components stored in the computer-readable media 804 may include an operating system 808 for controlling and managing various functions of the service computing device 102.

In addition, the computer-readable media 804 may store data used for performing the operations described herein. Thus, the computer-readable media 804 may store the buyer information 142, including buyer accounts 810, the merchant information 144, including merchant accounts 812, and the courier information 146, including courier accounts 814. Further, the computer-readable media may include the past order information 148, such as the merchant historic information 508, the buyer historic information 510, and the courier historic information 512. The service computing device 102 may also include or maintain other functional components and data not specifically shown, such as other modules and data 816, which may include programs, drivers, etc., and the data used or generated by the functional components. Further, the service computing device 102 may include many other logical, programmatic and physical components, of which those described above are merely examples that are related to the discussion herein.

The communication interface(s) 806 may include one or more interfaces and hardware components for enabling communication with various other devices, such as over the network(s) 106. For example, communication interface(s) 806 may enable communication through one or more of the Internet, cable networks, cellular networks, wireless networks (e.g., Wi-Fi) and wired networks (e.g., fiber optic and Ethernet), as well as close-range communications, such as BLUETOOTH®, BLUETOOTH® low energy, and the like, as additionally enumerated elsewhere herein.

The service computing device 102 may further be equipped with various input/output (I/O) devices 818. Such I/O devices 818 may include a display, various user interface controls (e.g., buttons, joystick, keyboard, mouse, touch screen, etc.), audio speakers, connection ports and so forth.

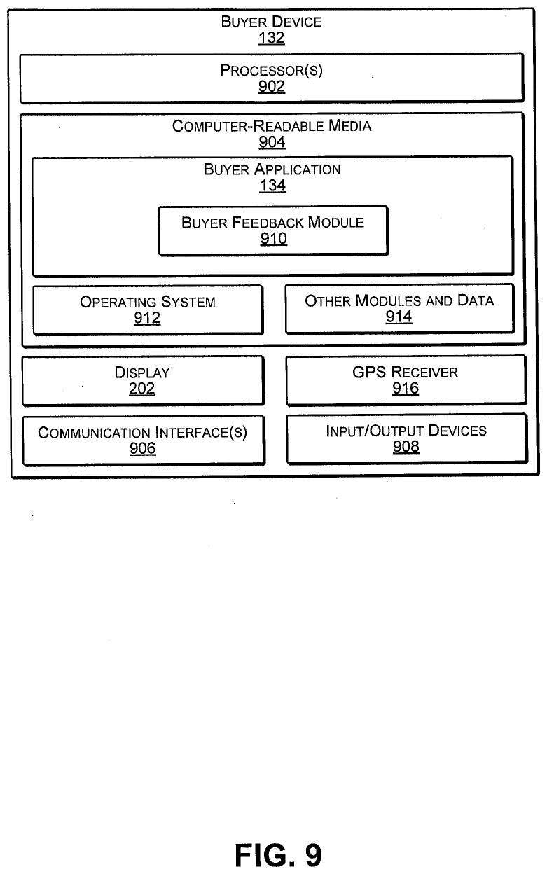

FIG. 9 illustrates select example components of the buyer device 132 that may implement the functionality described above according to some examples. The buyer device 132 may be any of a number of different types of portable computing devices or semi-portable computing devices. Some examples of the buyer device 132 may include smart phones and mobile communication devices; tablet computing devices; laptops, netbooks and other portable computers; wearable computing devices and/or body-mounted computing devices, which may include watches and augmented reality devices, such as helmets, goggles or glasses; and any other portable device capable of sending communications and performing the functions according to the techniques described herein. Further, in some examples, the buyer device 132 may be a stationary or semi-stationary computing device, such as a desktop computer or other device with computing capabilities.

In the example of FIG. 9, the buyer device 132 includes components such as at least one processor 902, one or more computer-readable media 904, one or more communication interfaces 906, and one or more input/output (I/O) devices 908. Each processor 902 may itself comprise one or more processors or processing cores. For example, the processor 902 can be implemented as one or more microprocessors, microcomputers, microcontrollers, digital signal processors, central processing units, state machines, logic circuitries, and/or any devices that manipulate signals based on operational instructions. In some cases, the processor 902 may be one or more hardware processors and/or logic circuits of any suitable type specifically programmed or configured to execute the algorithms and processes described herein. The processor 902 can be configured to fetch and execute computer-readable processor-executable instructions stored in the computer-readable media 904.

Depending on the configuration of the buyer device 132, the computer-readable media 904 may be an example of tangible non-transitory computer storage media and may include volatile and nonvolatile memory and/or removable and non-removable media implemented in any type of technology for storage of information such as computer-readable processor-executable instructions, data structures, program modules or other data. The computer-readable media 904 may include, but is not limited to, RAM, ROM, EEPROM, flash memory, solid-state storage, magnetic disk storage, optical storage, and/or other computer-readable media technology. Further, in some cases, the buyer device 132 may access external storage, such as RAID storage systems, storage arrays, network attached storage, storage area networks, cloud storage, or any other medium that can be used to store information and that can be accessed by the processor 902 directly or through another computing device or network. Accordingly, the computer-readable media 904 may be computer storage media able to store instructions, modules or components that may be executed by the processor 902. Further, when mentioned, non-transitory computer-readable media exclude media such as energy, carrier signals, electromagnetic waves, and signals per se.

The computer-readable media 904 may be used to store and maintain any number of functional components that are executable by the processor 902. In some implementations, these functional components comprise instructions or programs that are executable by the processor 902 and that, when executed, implement operational logic for performing the actions and services attributed above to the buyer device 132. Functional components of the buyer device 132 stored in the computer-readable media 904 may include the buyer application 134, as discussed above, which may present the buyer with one or more GUIs for placing an order, some examples of which are described above. For instance, the buyer application may include a buyer feedback module 910 that enables the buyer to provide feedback with respect to couriers, merchants, and/or delivered items. Additional functional components may include an operating system 912 for controlling and managing various functions of the buyer device 132 and for enabling basic user interactions with the buyer device 132.

In addition, the computer-readable media 904 may also store data, data structures and the like, that are used by the functional components. Depending on the type of the buyer device 132, the computer-readable media 904 may also optionally include other functional components and data, such as other modules and data 914, which may include applications, programs, drivers, etc., and the data used or generated by the functional components. Further, the buyer device 132 may include many other logical, programmatic and physical components, of which those described are merely examples that are related to the discussion herein.

The communication interface(s) 906 may include one or more interfaces and hardware components for enabling communication with various other devices, such as over the network(s) 106 or directly. For example, communication interface(s) 906 may enable communication through one or more of the Internet, cable networks, cellular networks, wireless networks (e.g., Wi-Fi) and wired networks (e.g., fiber optic, Ethernet), as well as close-range communications such as BLUETOOTH®, BLUETOOTH® low energy, and the like, as additionally enumerated elsewhere herein.

FIG. 9 further illustrates that the buyer device 132 may include the display 202. Depending on the type of computing device used as the buyer device 132, the display 202 may employ any suitable display technology. For example, the display 202 may be a liquid crystal display, a plasma display, a light emitting diode display, an OLED (organic light-emitting diode) display, an electronic paper display, or any other suitable type of display able to present digital content thereon. In some examples, the display 202 may have a touch sensor associated with the display 202 to provide a touchscreen display configured to receive touch inputs for enabling interaction with a GUI presented on the display 202. Accordingly, implementations herein are not limited to any particular display technology. Alternatively, in some examples, the buyer device 132 may not include a display.

The buyer device 132 may further include the one or more I/O devices 908. The I/O devices 908 may include speakers, a microphone, a camera, and various user controls (e.g., buttons, a joystick, a keyboard, a keypad, etc.), a haptic output device, and so forth. Other components included in the buyer device 132 may include various types of sensors, which may include a GPS receiver 916 able to indicate location information, as well as other sensors (not shown) such as an accelerometer, gyroscope, compass, proximity sensor, and the like. In some cases, the GPS receiver 916 may be used by the buyer application 134 to determine a current geographic location of the buyer device 132. Additionally, or alternatively, the communication interfaces 906 may be used to determine the current location of the buyer device 132, such as based on communication with nearby cell towers, wireless access points, and the like. In some examples, the buyer application 134 may send this location information to the service computing device as an indicated delivery location for the associated buyer. Additionally, the buyer device 132 may include various other components that are not shown, examples of which include removable storage, a power source, such as a battery and power control unit, and so forth.

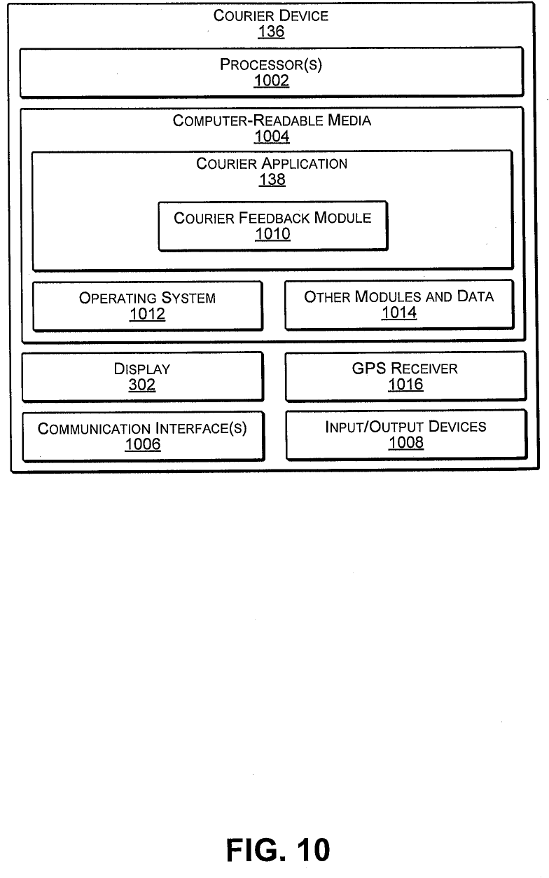

FIG. 10 illustrates select example components of the courier device 136 that may implement the functionality described above according to some examples. The courier device 136 may be any of a number of different types of portable computing devices. Some examples of the courier device 136 may include smart phones and mobile communication devices; tablet computing devices; laptops, netbooks and other portable computers; wearable computing devices and/or body-mounted computing devices, which may include watches and augmented reality devices, such as helmets, goggles or glasses; and any other portable device capable of sending communications and performing the functions according to the techniques described herein.

In the example of FIG. 10, the courier device 136 includes components such as at least one processor 1002, one or more computer-readable media 1004, one or more communication interfaces 1006, and one or more input/output (I/O) devices 1008. Each processor 1002 may itself comprise one or more processors or processing cores. For example, the processor 1002 can be implemented as one or more microprocessors, microcomputers, microcontrollers, digital signal processors, central processing units, state machines, logic circuitries, and/or any devices that manipulate signals based on operational instructions. In some cases, the processor 1002 may be one or more hardware processors and/or logic circuits of any suitable type specifically programmed or configured to execute the algorithms and processes described herein. The processor 1002 can be configured to fetch and execute computer-readable processor-executable instructions stored in the computer-readable media 1004.

Depending on the configuration of the courier device 136, the computer-readable media 1004 may be an example of tangible non-transitory computer storage media and may include volatile and nonvolatile memory and/or removable and non-removable media implemented in any type of technology for storage of information such as computer-readable processor-executable instructions, data structures, program modules or other data. The computer-readable media 1004 may include, but is not limited to, RAM, ROM, EEPROM, flash memory, solid-state storage, magnetic disk storage, optical storage, and/or other computer-readable media technology. Further, in some cases, the courier device 136 may access external storage, such as RAID storage systems, storage arrays, network attached storage, storage area networks, cloud storage, or any other medium that can be used to store information and that can be accessed by the processor 1002 directly or through another computing device or network. Accordingly, the computer-readable media 1004 may be computer storage media able to store instructions, modules or components that may be executed by the processor 1002. Further, when mentioned, non-transitory computer-readable media exclude media such as energy, carrier signals, electromagnetic waves, and signals per se.

The computer-readable media 1004 may be used to store and maintain any number of functional components that are executable by the processor 1002. In some implementations, these functional components comprise instructions or programs that are executable by the processor 1002 and that, when executed, implement operational logic for performing the actions and services attributed above to the courier device 136. Functional components of the courier device 136 stored in the computer-readable media 1004 may include the courier application 138, as discussed above, which may present the courier with one or more GUIs, some examples of which are described above. In some examples, the courier application 138 may include a courier feedback module 1010 that may be executed to enable the courier to provide feedback regarding at least one of buyers, merchants, and/or items. Additional functional components may include an operating system 1012 for controlling and managing various functions of the courier device 136 and for enabling basic user interactions with the courier device 136.

In addition, the computer-readable media 1004 may also store data, data structures and the like, that are used by the functional components. Depending on the type of the courier device 136, the computer-readable media 1004 may also optionally include other functional components and data, such as other modules and data 1014, which may include applications, programs, drivers, etc., and the data used or generated by the functional components. Further, the courier device 136 may include many other logical, programmatic and physical components, of which those described are merely examples that are related to the discussion herein.

The communication interface(s) 1006 may include one or more interfaces and hardware components for enabling communication with various other devices, such as over the network(s) 106 or directly. For example, communication interface(s) 1006 may enable communication through one or more of the Internet, cable networks, cellular networks, wireless networks (e.g., Wi-Fi) and wired networks (e.g., fiber optic, Ethernet), as well as close-range communications such as BLUETOOTH®, BLUETOOTH® low energy, and the like, as additionally enumerated elsewhere herein.

FIG. 10 further illustrates that the courier device 136 may include the display 302, which may be the any of the types of displays 202 described above with respect to the buyer device 132. The courier device 136 may further include the one or more I/O devices 1008. The I/O devices 1008 may include speakers, a microphone, a camera, and various user controls (e.g., buttons, a joystick, a keyboard, a keypad, etc.), a haptic output device, and so forth. Other components included in the courier device 136 may include various types of sensors, which may include a GPS receiver 1016 able to indicate location information, as well as other sensors (not shown) such as an accelerometer, gyroscope, compass, proximity sensor, and the like. In some cases, the GPS receiver 1016 may be used by the courier application 138 to determine a current geographic location of the courier device 136. Additionally, or alternatively, the communication interfaces 1006 may be used to determine the current location of the courier device, such as based on communication with nearby cell towers, wireless access points, and the like. In some examples, the courier application 138 may send this location information periodically to the service computing device as an indicated location of the associated courier. Additionally, the courier device 136 may include various other components that are not shown, examples of which include removable storage, a power source, such as a battery and power control unit, and so forth.

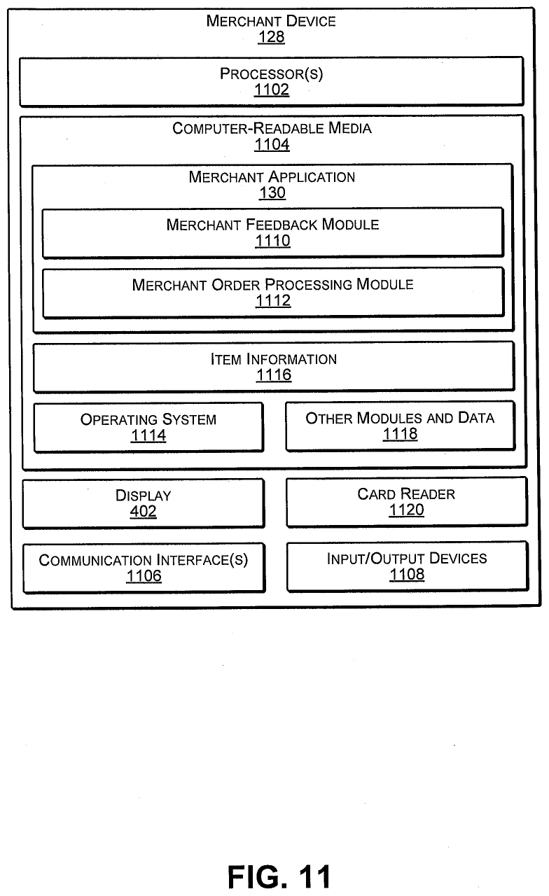

FIG. 11 illustrates select example components of an example merchant device 128 according to some implementations. The merchant device 128 may be any suitable type of computing device, e.g., portable, semi-portable, semi-stationary, or stationary. Some examples of the merchant device 128 may include tablet computing devices; smart phones and mobile communication devices; laptops, netbooks and other portable computers or semi-portable computers; desktop computing devices, terminal computing devices and other semi-stationary or stationary computing devices; dedicated register devices; wearable computing devices or other body-mounted computing devices; augmented reality devices; or other computing devices capable of sending communications and performing the functions according to the techniques described herein.

In the illustrated example, the merchant device 128 includes at least one processor 1102, one or more computer-readable media 1104, one or more communication interfaces 1106, and one or more input/output (I/O) devices 1108. Each processor 1102 may itself comprise one or more processors or processing cores. For example, the processor 1102 can be implemented as one or more microprocessors, microcomputers, microcontrollers, digital signal processors, central processing units, state machines, logic circuitries, and/or any devices that manipulate signals based on operational instructions. In some cases, the processor 1102 may be one or more hardware processors and/or logic circuits of any suitable type specifically programmed or configured to execute the algorithms and processes described herein. The processor 1102 can be configured to fetch and execute computer-readable processor-executable instructions stored in the computer-readable media 1104.

Depending on the configuration of the merchant device 128, the computer-readable media 1104 may be an example of tangible non-transitory computer storage media and may include volatile and nonvolatile memory and/or removable and non-removable media implemented in any type of technology for storage of information such as computer-readable processor-executable instructions, data structures, program modules or other data. The computer-readable media 1104 may include, but is not limited to, RAM, ROM, EEPROM, flash memory, solid-state storage, magnetic disk storage, optical storage, and/or other computer-readable media technology. Further, in some cases, the merchant device 128 may access external storage, such as RAID storage systems, storage arrays, network attached storage, storage area networks, cloud storage, or any other medium that can be used to store information and that can be accessed by the processor 1102 directly or through another computing device or network. Accordingly, the computer-readable media 1104 may be computer storage media able to store instructions, modules, or components that may be executed by the processor 1102. Further, when mentioned, non-transitory computer-readable media exclude media such as energy, carrier signals, electromagnetic waves, and signals per se.

The computer-readable media 1104 may be used to store and maintain any number of functional components that are executable by the processor 1102. In some implementations, these functional components comprise instructions or programs that are executable by the processor 1102 and that, when executed, implement operational logic for performing the actions and services attributed above to the merchant device 128. Functional components of the merchant device 128 stored in the computer-readable media 1104 may include the merchant application 130. In this example, the merchant application 130 includes a merchant feedback module 1110 and a merchant order processing module 1112. For example, the feedback module 1110 may present an interface, such as the GUI 400 discussed above with respect to FIG. 4, to enable the merchant to provide feedback regarding couriers. Further, the merchant order processing module 1112 may present an interface to enable the merchant to manage received orders, sending estimated item preparation time, view locations of couriers assigned to pick up orders from the merchant, and the like. Additional functional components may include an operating system 1114 for controlling and managing various functions of the merchant device 128 and for enabling basic user interactions with the merchant device 128.

In addition, the computer-readable media 1104 may also store data, data structures and the like, that are used by the functional components. For example, data stored by the computer-readable media 1104 may include item information 1116 that includes information about the items offered by the merchant, which may include a list of items currently available from the merchant, images of the items, descriptions of the items, prices of the items, and so forth. Depending on the type of the merchant device 128, the computer-readable media 1104 may also optionally include other functional components and data, such as other modules and data 1118, which may include programs, drivers, etc., and the data used or generated by the functional components. Further, the merchant device 128 may include many other logical, programmatic, and physical components, of which those described are merely examples that are related to the discussion herein.

The communication interface(s) 1106 may include one or more interfaces and hardware components for enabling communication with various other devices, such as over the network(s) 106 or directly. For example, communication interface(s) 1106 may enable communication through one or more of the Internet, cable networks, cellular networks, wireless networks (e.g., Wi-Fi) and wired networks, as well as close-range communications such as Bluetooth®, Bluetooth® low energy, and the like, as additionally enumerated elsewhere herein.

FIG. 11 further illustrates that the merchant device 128 may include the display 402 mentioned above, which may be any of the types of displays discussed above with respect to the buyer device display 202. The merchant device 128 may further include the one or more I/O devices 1108. The I/O devices 1108 may include speakers, a microphone, a camera, and various user controls (e.g., buttons, a joystick, a keyboard, a keypad, etc.), a haptic output device, and so forth.

In addition, the merchant device 128 may include or may be connectable to a card reader 1120. In some examples, the card reader may plug in to a port in the merchant device, such as a microphone/headphone port, a data port, or other suitable port. The card reader may include a read head for reading a magnetic strip of a payment card, and further may include encryption technology for encrypting the information read from the magnetic strip. Alternatively, numerous other types of card readers may be employed with the merchant devices 104 herein, depending on the type and configuration of the merchant device 128.

Other components included in the merchant device 128 may include various types of sensors (not shown), which may include a GPS receiver able to indicate location information, as well as other sensors such as an accelerometer, gyroscope, compass, proximity sensor, and the like. Additionally, the merchant device 128 may include various other components that are not shown, examples of which include removable storage, a power source, such as a battery and power control unit, and so forth.

Various instructions, methods, and techniques described herein may be considered in the general context of computer-executable instructions, such as program modules stored on computer-readable media, and executed by the processor(s) herein. Generally, program modules include routines, programs, objects, components, data structures, etc., for performing particular tasks or implementing particular abstract data types. These program modules, and the like, may be executed as native code or may be downloaded and executed, such as in a virtual machine or other just-in-time compilation execution environment. Typically, the functionality of the program modules may be combined or distributed as desired in various implementations. An implementation of these modules and techniques may be stored on computer storage media or transmitted across some form of communication media.

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

1. A system comprising:
one or more service computing devices, each including a service computing device processor, and a service computing device communication interface coupled to the service computing device processor for communicating over one or more networks with a plurality of courier devices, a plurality of merchant devices, and a plurality of buyer devices, the one or more service computing devices programmed to:
receive, from the plurality of merchant devices associated with a plurality of respective merchants, a first plurality of feedback communications including at least one of ratings or text comments related to individual couriers of a plurality of couriers associated with the plurality of courier devices, respectively, wherein respective feedback communications correspond to respective delivery orders picked up by individual couriers from the respective merchants;
receive, from the plurality of buyer devices associated with a plurality of respective buyers, a second plurality of feedback communications including at least one of ratings or text comments related to the individual couriers, wherein respective feedback communications of the second plurality of feedback communications correspond to respective delivery orders delivered by the individual couriers to the respective buyers;
determine, for the individual couriers, first respective courier scores for the respective merchants based on the first plurality of feedback communications received from the plurality of merchant devices, and second respective courier scores for the respective buyers based on the second plurality of feedback communications received from the buyer devices;
receive, from a plurality of courier devices associated with a plurality of respective couriers, respective electronic communications indicating respective locations of the courier devices based at least in part on respective geographic locations of the courier devices determined through information from respective courier device GPS receivers;
receive, from a first buyer device of the plurality of buyer devices, a first order for delivery of a first item available from a first merchant of the plurality of merchants to a delivery location, wherein the first buyer device is associated with a first buyer;
determine, based on the respective locations of the courier devices, predicted courier travel times, and a first item preparation time, a subset of courier devices within a threshold distance of a pickup location associated with the first merchant;
train a first machine-learning model using historic courier information for a plurality of past predicted courier travel times and a plurality of actual courier travel times for a plurality of past orders;
train a second machine-learning model using spoilage time information including merchant provided spoilage times and spoilage feedback received from at least one of a plurality of buyers or a plurality of couriers associated with the plurality of past orders;
determine, for the individual couriers, based at least in part on the first machine-learning model, a third respective courier score based on comparing the past predicted courier travel times for the individual couriers for respective past orders delivered by the individual couriers with actual courier travel times for the individual couriers for the respective past orders;
select, from a subset of couriers associated with the subset of courier devices, a first courier to pick up the first item from the first merchant and deliver the first item to the delivery location, wherein selecting the first courier is based at least in part on the first respective courier score associated with the first courier for the first merchant, the second respective courier score associated with the first courier for the first buyer, and the third respective courier score determined for the first courier;
send, to a first courier device associated with the first courier, order information for assigning delivery of the first order to the first courier;
receive at least one of a first plurality of electronic communications from a plurality of the buyer devices that received delivery of the first item, or a second plurality of electronic communications from a plurality of the courier devices associated with delivery of the first item to delivery locations associated with the plurality of buyer devices;
input information related to the at least one of the first plurality of electronic communications or the second plurality of communications into the second machine learning model to determine a change to the spoilage time for the first item; and
adjust a delivery area for the first item based at least on the change to the spoilage time for the first item.

2. The system as recited in claim 1, wherein the one or more service computing devices are further programmed to:
receive, from the first courier device, courier feedback communications related to at least one of the first merchant or the first buyer, wherein the selecting is further based at least in part on the courier feedback communications received from the first courier device.

3. The system as recited in claim 1, wherein at least one of the first plurality of feedback communications or the second plurality of feedback communications include the text comments, and wherein the one or more service computing devices are further programmed to:
search text of the text comments based at least in part on comparing words in the text with a plurality of reference words, to determine at least one of:
at least one word in the text indicative of merchant feedback related to the individual couriers; or
at least one word in the text indicative of buyer feedback related to the individual couriers;
classify the text comments into one or more comment classifications, wherein the comment classifications are associated with respective numerical values, wherein the text comments from the merchants are associated with a first set of comment classifications and the text comments from the buyers are associated with a second set of comment classifications; and
determine, for the individual couriers, the first respective courier scores for the respective merchants based at least in part on the numerical values associated with the first set of comment classifications, and the second respective courier scores for the respective buyers based at least in part on the second set of comment classifications.

4. The system as recited in claim 1, wherein the one or more service computing devices are further programmed to:
determine from order information associated with the respective delivery orders for which the feedback communications were received from the buyer devices, an item category for one or more items associated with the respective delivery orders delivered by the individual couriers to the respective buyers;
determine, for the individual couriers, third respective courier scores for respective item categories based on the feedback communications received from the buyer devices; and
wherein the selecting is further based at least in part on the third respective courier scores for a particular item category associated with the first item.

5. A method comprising:
training, by one or more computing devices, a first machine-learning model using historic courier information for a plurality of past predicted courier travel times and a plurality of actual courier travel times for a plurality of past orders;
training, by the one or more computing devices, a second machine-learning model using spoilage time information including merchant provided spoilage times and spoilage feedback received from at least one of a plurality of buyers or a plurality of couriers associated with the plurality of past orders;
receiving, by the one or more computing devices, from a plurality of courier devices associated with a plurality of respective couriers, respective electronic communications indicating respective locations of the courier devices based at least in part on respective geographic locations of the courier devices determined through information from the respective courier device GPS receivers;
receiving, by the one or more computing devices, from a buyer device, an order for delivery of a first item from a merchant to a delivery location;
determining, by the one or more computing devices, based on the respective locations of the courier devices, predicted courier travel times, and a first item preparation time, a subset of courier devices within a threshold distance of a pickup location associated with the merchant;
determining, by the one or more computing devices, for individual couriers of the plurality of couriers, based at least in part on the first machine-learning model, a respective courier score based on comparing the past predicted courier travel times for the individual couriers for respective past orders delivered by the individual couriers with actual courier travel times for the individual couriers for the respective past orders;
selecting, by the one or more computing devices, from a subset of couriers associated with the subset of courier devices, a courier to pick up the first item from the merchant and deliver the first item to the delivery location, wherein the selecting is based at least in part on the respective courier score;
receiving, by the one or more computing devices, at least one of a first plurality of electronic communications from a plurality of the buyer devices that received delivery of the first item, or a second plurality of electronic communications from a plurality of the courier devices associated with delivery of the first item to delivery locations associated with the plurality of buyer devices;
inputting, by the one or more computing devices, information related to the at least one of the first plurality of electronic communications or the second plurality of communications into the second machine learning model to determine a change to the spoilage time for the first item; and
adjusting, by the one or more computing devices, a delivery area for the first item based at least on the change to the spoilage time for the first item.

6. The method as recited in claim 5, wherein the selecting is further based at least in part on one or more courier feedback communications received from a courier device associated with the courier with respect to the merchant for the one or more past orders picked up from the merchant.

7. The method as recited in claim 5, wherein the selecting is further based at least in part on one or more buyer feedback communications received from the buyer device with respect to the courier for one or more past orders placed by a buyer associated with the buyer device.

8. The method as recited in claim 5, wherein the selecting is further based at least in part on one or more courier feedback communications received from a courier device associated with the courier with respect to the buyer for one or more past orders placed by a buyer associated with the buyer device.

9. The method as recited in claim 5, wherein the selecting is further based at least in part on one or more buyer feedback communications received with respect to items categorized in a same item category as the first item and delivered by the courier for a plurality of past orders placed by a plurality of buyers.

10. The method as recited in claim 5, wherein the actual courier travel times are determined, at least in part, from the respective electronic communications indicating respective locations of the courier device determined through information from the respective courier device GPS receiver.

11. The method as recited in claim 5, further comprising:
receiving, from a merchant device associated with the merchant, employee login information associated with a particular employee of the merchant; and
selecting the courier based at least in part on at least one of:
merchant feedback received from the merchant device in the past while the particular employee was logged in to the merchant device; or
courier feedback received from the courier device in the past while the particular employee was logged in to the merchant device.

12. The method as recited in claim 5, wherein the selecting is based at least in part on merchant feedback received with respect to the courier for one or more past orders picked up from the merchant, the feedback from the merchant including one or more text comments, the method further comprising:
searching text of the one or more text comments based at least in part on comparing words in the text with a plurality of reference words, to determine at least one word in the text indicative of merchant feedback related to the courier;
classifying the one or more text comments into one or more respective comment classifications, wherein the comment classifications are associated with respective numerical values;
determining, for the courier, a courier merchant score with respect to the merchant based at least in part the numerical values associated with the comment classifications; and
selecting the courier based at least in part on the courier merchant score associated with the merchant being higher than a courier merchant score of another courier in the subset.

13. The method as recited in claim 5, further comprising:
determining that the courier has received positive feedback from a plurality of merchants;
determining an other merchant has provided negative feedback to a plurality of other couriers; and
assigning the courier to pick up a subsequent order from a pickup location associated with the other merchant to determine a trustworthiness of the negative feedback provided by the other merchant.

14. One or more non-transitory computer-readable media maintaining instructions that, when executed by one or more processors, program the one or more processors to:
train, by the one or more processors, a first machine-learning model using historic courier information for a plurality of past predicted courier travel times and a plurality of actual courier travel times for a plurality of past orders;
train, by the one or more processors, a second machine-learning model using spoilage time information including merchant provided spoilage times and spoilage feedback received from at least one of a plurality of buyers or a plurality of couriers associated with the plurality of past orders;
receive, by the one or more processors, from a merchant device associated with a merchant, merchant feedback related to a courier of a plurality of couriers, wherein the merchant feedback corresponds to one or more delivery orders picked up by the courier from a pickup location associated with the merchant;
receive, by the one or more processors, from a courier device associated with the courier, courier feedback related to the merchant, wherein the courier feedback corresponds to the one or more delivery orders picked up by the courier from the pickup location;
determine, by the one or more processors, for individual couriers of the plurality of couriers, based at least in part on the first machine-learning model, a respective courier score based on comparing the past predicted courier travel times for the individual couriers for respective past orders delivered by the individual couriers with actual courier travel times for the individual couriers for the respective past orders;
receive, by the one or more processors, from a buyer device, an order for delivery of a first item from the merchant to a delivery location;
select, by the one or more processors, the courier to pick up the first item from the pickup location and deliver the first item to the delivery location based at least in part on the merchant feedback received from the merchant device, the courier feedback received from the courier device, and the respective courier score determined for the courier;
receive, by the one or more processors, at least one of a first plurality of electronic communications from a plurality of the buyer devices that received delivery of the first item, or a second plurality of electronic communications from a plurality of the courier devices associated with delivery of the first items to delivery locations associated with the plurality of buyer devices;
input, by the one or more processors, information related to the at least one of the first plurality of electronic communications or the second plurality of communications into the second machine learning model to determine a change to the spoilage time for the first item; and
adjust, by the one or more processors, a delivery area for the first item based at least on the change to the spoilage time for the first item.

15. The one or more non-transitory computer-readable media as recited in claim 14, wherein the instructions further program the one or more processors to:
receive, from the courier device associated with the courier, one or more electronic communications indicating a location of the courier device based at least in part on a geographic location of the courier device determined through information from a courier device GPS receiver;
determine, based on the location of the courier device, a predicted courier travel time to the pickup location associated with the merchant; and
select the courier based at least in part on the predicted courier travel time to the pickup location being predicted to be less than a first item preparation time for the first item.

16. The one or more non-transitory computer-readable media as recited in claim 15, wherein the instructions further program the one or more processors to determine the first item preparation time based on at least one of:
receiving the first item preparation time from the merchant in response to sending order information to the merchant; or
retrieving the first item preparation time from item preparation information maintained in a storage.

17. The one or more non-transitory computer-readable media as recited in claim 14, wherein the instructions further program the one or more processors to:
receive, from the merchant device, employee login information associated with a particular employee of the merchant; and
select the courier based at least in part on at least one of:
the merchant feedback received from the merchant device while the particular employee is logged in to the merchant device; or
the courier feedback received from the courier device for orders picked up by the courier while the particular employee is logged in to the merchant device.

18. The one or more non-transitory computer-readable media as recited in claim 17, wherein the instructions further program the one or more processors to:
determine that the courier has received positive feedback from a plurality of merchants and a plurality of buyers;
determine another employee of another merchant has given negative feedback to a plurality of other couriers; and
assign the courier to pick up a subsequent order from a pickup location associated with the other merchant to determine a trustworthiness of the negative feedback provided by the other employee.

19. The one or more non-transitory computer-readable media as recited in claim 14, wherein the instructions further program the one or more processors to:
select the courier based at least in part on buyer feedback for the courier received from the buyer device in association with at least one order previously delivered by the courier to the delivery location.

20-24. (canceled)

25. A computing device able to communicate over a network with a plurality of courier devices and at least one buyer device, the computing device configured to perform operations comprising:
training a first machine-learning model using historic courier information for a plurality of past predicted courier travel times and a plurality of actual courier travel times for a plurality of past orders;
training a second machine-learning model using spoilage time information including merchant provided spoilage times and spoilage feedback received from at least one of a plurality of buyers or a plurality of couriers associated with the plurality of past orders;
receiving, from a plurality of courier devices associated with a plurality of respective couriers, respective electronic communications indicating respective locations of the courier devices based at least in part on respective geographic locations of the courier devices determined through information from the respective courier device GPS receivers;
receiving, from a buyer device, an order for delivery of a first item from a merchant to a delivery location;
determining, based on the respective locations of the courier devices, predicted courier travel times, and a first item preparation time, a subset of courier devices within a threshold distance of a pickup location associated with the merchant;
determining, for individual couriers of the plurality of couriers, based at least in part on the first machine-learning model, a respective courier score based on comparing the past predicted courier travel times for the individual couriers for respective past orders delivered by the individual couriers with actual courier travel times for the individual couriers for the respective past orders;
selecting, by the computing device, from a subset of couriers associated with the subset of courier devices, a courier to pick up the first item from the merchant and deliver the first item to the delivery location, wherein the selecting is based at least in part on the respective courier score;
receiving at least one of a first plurality of electronic communications from a plurality of the buyer devices that received delivery of the first item, or a second plurality of electronic communications from a plurality of the courier devices associated with delivery of the first items to delivery locations associated with the plurality of buyer devices;
inputting information related to the at least one of the first plurality of electronic communications or the second plurality of communications into the second machine learning model to determine a change to the spoilage time for the first item; and
adjusting a delivery area for the first item based at least on the change to the spoilage time for the first item.

26. The computing device as recited in claim 25, the operations further comprising:
receiving, from a merchant device associated with the merchant, employee login information associated with a particular employee of the merchant; and
selecting the courier based at least in part on at least one of:
merchant feedback received from the merchant device in the past while the particular employee was logged in to the merchant device; or
courier feedback received from the courier device in the past while the particular employee was logged in to the merchant device.

27. The computing device as recited in claim 25, wherein the actual courier travel times are determined, at least in part, from the respective electronic communications indicating respective locations of the courier device determined through information from the respective courier device GPS receiver.

28. The computing device as recited in claim 25, wherein the selecting is further based at least in part on one or more buyer feedback communications received with respect to items categorized in a same item category as the first item and delivered by the courier for a plurality of past orders placed by a plurality of buyers.
